(19) United States
(12) Patent Application Publication
(10) Pub. No.: US 2010/0250955 A1
(43) Pub. Date: Sep. 30, 2010

(54) Brokered information sharing system

(76) Inventors: Paul Trevithick, Chestnut Hill, MA (US); Drummond Reed, Seattle, WA (US); Markus Sabadello, Vienna (AT); Thomas Carroll, Norwood, MA (US); John Bradley, Cultus Lake (CA); Brian Walker, Holden, MA (US)

Correspondence Address: Iandiorio Teska & Coleman, 260 Bear Hill Road, Waltham, MA, 02451, US

(21) Appl. No.: 12/589,372

(22) Filed: Oct. 22, 2009

Related U.S. Application Data
(60) Provisional application No. 61/196,931, filed on Oct. 22, 2008.

(51) Int. Cl. H04L 9/32; G06F 7/04; G06F 21/00

(52) U.S. Cl. 713/185; 726/5; 726/9

(57) ABSTRACT

A brokered information sharing system including a primary broker configured with software to store cards of a principal, to transmit the cards when requested by the principal, to authenticate the principal, and to provide a master authentication of the principal to at least one issuing party. A selector is used by the principal and is configured with software to provide authentication of the principal to the primary broker, and to request and receive cards from the primary broker.

### RELATED APPLICATIONS

This application hereby claims the benefit of and priority to U.S. Provisional Application Ser. No. 61/196,931, filed on Oct. 22, 2008, under 35 U.S.C. §§119, 120, 363, 365, and 37 C.F.R. §1.55 and §1.78, which is incorporated herein by reference.

### FIELD OF THE INVENTION

The subject invention relates to sharing of information over a network such as the Internet.

### BACKGROUND OF THE INVENTION

The Internet has become a ubiquitous means for access and exchange of digital information. It is comprised of computers and computer networks interconnected through communication links and exchanging information via protocols such as Transmission Control Protocol/Internet Protocol (“TCP/IP”), Simple Mail Transport Protocol (“SMTP”), HyperText Transfer Protocol (“HTTP”), Extensible Messaging and Presence Protocol (“XMPP”), and Session Initiation Protocol (“SIP”).

These and other protocols, both standardized and proprietary, enable the devices connected to the Internet to intercommunicate to share many different types of information for many different purposes. Three of the most popular applications for communications and data sharing are email, web browsing, and Voice-Over-IP (VOIP).

As the utility of these and other Internet applications has grown, so has the need to use them for sharing private data—data to which access must be controlled in order to ensure privacy, security, and confidentiality. An early example was the need to protect credit card information required to complete transactions on e-commerce sites. In order for consumers to trust sharing entering this information into a web browser and sending it over the Internet, the industry needed to develop a secure version of HTTP called HTTPS. This uses a protocol originally called Secure Sockets Layer (SSL) and now known as Transport Layer Security (TLS). TLS secures data transmissions using digital cryptography as specified in the Internet Engineering Task Force (IETF) Request For Comment (RFC) 4346 “The Transport Layer Security (TLS) Protocol Version 1.1” (http://tools.ietf.org/html/rfc4346), hereby incorporated by reference herein.

Users of a web browser can recognize when TLS security is being employed by looking for a small lock icon (typically in a corner of the browser), or a special background coloring of their browser address bar (where the web site address appears), or other visual or auditory cues. This increases the confidence of users and sites that the information entered into a web form will be transmitted securely between the browser and the site.

Although TLS and other transport security protocols can ensure the security and confidentiality of data transmitted over the transport channel, they do not by themselves solve the problem of authenticating the identity of either the user or the site involved in the data sharing transaction. Users still need to submit security credentials to sites to prove their identity to sites, and sites need to obtain trusted digital certificates from certificate authorities in order to prove their identity to users or other sites.

The most commonly employed user credential is a username and password, typically submitted by typing into a web form. Unfortunately this type of credential is susceptible to a “phishing” attack in which the identity of the site is faked by an attacker, fooling the user into entering their username and password into the attacker's web form. Such attacks are described in detail in “Understanding Windows CardSpace: An Introduction to the Concepts and Challenges of Digital Identities” by Vittorio Bertocci, Garrett Serack, and Caleb Baker (ISBN 0-321-49684-1, Pearson Technologies Inc., 2008), hereby incorporated by reference herein.

The above book also describes the solution originally developed by Microsoft referred to as information cards and identity selectors. Broadly speaking, this is a system to simplify, automate, and very significantly increase the security of the process of users submitting digital identity credentials to websites, web services, and other resources both on the Internet and enterprise networks by using a standard credential format called an information card or “i-card” and standard software program and interface for selecting and managing i-cards called an identity selector or just “selector”. Information cards and identity selectors are described in detail in the book “Understanding Windows CardSpace”, which also contains references to the current information card interaction and transaction specifications published by OASIS IMI Technical Committee (http://www.oasis-open.org/committees/imi) and referred to herein as the “IMI” specifications”.

This information card architecture has been further extended by the Higgins Project, an open source project of the Eclipse Foundation (http://www.eclipse.org/higgins/). The Higgins Project uses the shorter term “i-card” to refer to all types of information cards, including new types not defined by Microsoft's IMI specification.

Whether data is transmitted to a site via TLS or other transport security protocols, and whether it is delivered via an information card security token, once the data is received the receiving site has the keys to decrypt the data. Further security and confidentiality are its responsibility. This may be adequate if the site is the final consumer of the data, or if it is trusted by the user to relay the data securely and confidentially to other third parties selected and controlled by the site. However users may wish to use a new intermediary service that manages the distribution and sharing of the data from parties that the user selects to parties that the user selects.

Furthermore, the IMI specifications were designed under the general assumption that the user's “wallet” of i-cards, often called the cardstore, is stored locally on the same device hosting the identity selector. However some of the identity selectors under development in the Higgins Project do not make that assumption—they are designed with the assumption that the cardstore is either only “in the cloud” or is synchronized between a local store and the cloud, i.e, available as a service over the Internet, an approach referred to in the industry as “cloud computing” and “software as a service” (SaaS).

To support a cloud-based digital identity approach, also called “identity-as-a-service”, however, the user of the service, referred to as the principal, must be able to provision a selector and a wallet service provider, and this provisioning must meet special security and privacy protection requirements. Furthermore, a cloud-based identity service provider, referred to as a broker, must be able to support the principal's requirements for convenience, ease-of-use, and performance, all while protecting the principal's security and privacy at the same level expected of commercial banks, government agencies, or other highly trusted service providers.

Therefore there exists a need for a method and system that enables a principal to create and control information sharing relationships over a network.

### BRIEF SUMMARY OF THE INVENTION

It is therefore an object of at least one embodiment of the subject invention to provide a system for and method of enabling a principal to create and control an information sharing relationship over a network.

It is a further object of at least one embodiment of the subject invention to provide such a system and method wherein the principal can more easily and safely share information.

It is a further object of at least one embodiment of the subject invention to provide such a system and method whereby the principal can control which parties on the network have access to the principal's information.

It is a further object of at least one embodiment of the subject invention to provide such a system and method wherein the principal's control over the principal's information is not tied to any specific device.

It is a further object of at least one embodiment of the subject invention to provide such a system and method whereby the principal is able to maintain service even if a password or other authentication credentials are lost.

It is a further object of at least one embodiment of the subject invention to provide such a system and method which maintains service to the principal even if the principal's devices and/or access software is lost or becomes nonfunctional.

It is a further object of at least one embodiment of the subject invention to provide such a system and method which maintains the security of the principal's information.

It is a further object of at least one embodiment of the subject invention to provide such a system and method which maintains the principal's privacy.

It is a further object of at least one embodiment of the subject invention to provide such a system and method which requires the principal to provide authorization only once for using one or more cards.

Embodiments of the invention result from the realization that it is more convenient for a principal that uses one or more cards to provide authentication only once to a broker and have the broker assert the principal's authentication to one or more issuing parties rather than having the principal provide authorization numerous times.

The subject invention, however, in other embodiments, need not achieve all these objectives and the claims hereof should not be limited to structures or methods capable of achieving these objectives.

This invention features a brokered information sharing system comprising a primary broker configured with software to store cards of a principal, to transmit said cards when requested by the principal, to authenticate the principal, and to provide a master authentication of the principal to at least one issuing party, and a selector used by the principal and configured with software to provide authentication of the principal to the primary broker, and to request and receive cards from the primary broker.

In one embodiment, the master authentication may be for authenticating a plurality of the cards each selected by the selector. The selector may be programmed to analyze a security policy provided by an information source and the selector includes a communications module configured to compose a message transmitted to the remote broker. The message may include a broker password which allows access to the primary broker. The primary broker may include programming for verifying the broker password. The primary broker may include one or more databases for storing the cards and a data adapter which queries the databases in accordance with the message. The primary broker may be further configured to authenticate a card transmitted to the selector upon request by the selector. The selector may be programmed to request a card authenticated from the primary broker. The selector may include a cryptography module which produces a security token based on the card authentication transmitted from the primary broker. The authentication may include a selector identification and a password. At least some of the information in the cards may be stored at the primary broker may be encrypted. At least one encryption key for the cards and an encryption key repository may be remote from the broker for storing the at least one encryption key. The selector may be programmed to retrieve the encryption key from the encryption key repository for decrypting an encrypted card transmitted to the selector by the broker. The software of the primary broker may be configured to store the cards remotely from the selector. The primary broker may use one or more devices or methods for authenticating the principal. The primary broker may authenticate the principal using device fingerprinting. The primary broker may authenticate the principal using a trusted platform module. The primary broker may authenticate the principal using IP address authentication. The primary broker may authenticate the principal using knowledge based authentication. The primary broker may authenticate the principal using a broker-issued one-time password. The primary broker may authenticate the principal using a hardware authentication token mechanism. The primary broker may authenticate the principal using a software authentication token mechanism. The primary broker may authenticate the principal using broker heuristics. The broker heuristics may use information relating to the enrollment of the principal in a card wallet service. The broker heuristics may use information relating to the characteristics of a card wallet of the principal. The broker heuristics may use information relating to the cards in a card wallet of the principal. The broker heuristics may use information relating to the characteristics of a group of cards from a card wallet of the principal.

This invention also features a brokered information sharing system for a principal using a selector, the system comprising a primary broker configured with software to remotely store cards of a principal, to transmit said cards when requested by the principal, and to authenticate the principal upon request by the selector, and to provide a master authentication of the principal to at least one issuing party. The selector is used by the principal and configured with software to request cards from the broker, to receive cards transmitted from the broker, and to request card authentication from the broker.

This invention further features a brokered information sharing system comprising a primary broker remote from a principal which includes a database for storing cards of a principal, the cards having at least some information therein encrypted, a data adapter configured to query the database in response to a message, means for authenticating a retrieved card, and means for transmitting the card and the authentication. A selector includes a communications module configured to compose the message based on a security policy and to transmit the message to the primary broker, and a cryptography module configured to provide a security token based on the authentication received from the primary broker. An encryption key repository is configured to store at least one encryption key of the principal and to transmit the encryption key to the selector upon request by the selector to decrypt the encrypted information in a card transmitted to the selector by the primary broker.

In another embodiment, the message may include a broker password which allows access to the primary broker. The primary broker may include programming for verifying the broker password. The authentication may include a selector identification and a password.

This invention further features a brokered information sharing system comprising a primary broker comprising means for storing cards of a principal, means for transmitting a said card when requested by the principal, means for authenticating the principal, and means for providing a master authentication of the principal to at least one issuing party, and a selector used by the principal and including means for requesting cards from the remote broker and to receive cards transmitted from the broker.

This invention further features a brokered information sharing method comprising configuring a primary broker to remotely store cards of a principal and to transmit cards when requested by the principal, to authenticate the principal, and to provide a master authentication of the principal to at least one issuing party, and to configure a selector for use by the principal to request cards from the remote broker and to receive cards transmitted from the broker.

In another embodiment, the selector may analyze a security policy provided by an information source and compose a message transmitted to the remote broker. The message may include a broker password which allows access to the primary broker. The primary broker may verify the broker password. The primary broker may include one or more databases for storing the cards and the broker queries the databases in accordance with the message. The primary broker may authenticate a card transmitted to the selector upon request by the selector. The selector may request a card authenticated from the primary broker. The selector may produce a security token based on the card authorization transmitted from the primary broker. The authentication may include a selector identification and a password. The cards stored at the primary broker may be encrypted. At least one encryption key for the cards may be stored at an encryption key repository remote from the broker. The selector may retrieve the encryption key from the encryption key repository for decrypting an encrypted card transmitted to the selector by the broker.

This invention further features a brokered information sharing method comprising configuring a primary broker with software to store cards of a principal, to transmit said cards when requested by the principal, and to authenticate the principal upon request by the selector, and to provide a master authentication of the principal to at least one issuing party, and configuring a selector used by the principal with software to request cards from the remote broker, to receive cards transmitted from the broker, and to request card authentication from the primary broker.

This invention further features a brokered information sharing method comprising provisioning a primary broker remote from a principal to: store encrypted cards of a principal in a database, query the database in response to a message, authenticate a retrieved card, and transmit the card and the authentication. A selector is provisioned to: compose the message based on a security policy and to transmit the get card message to the primary broker, and provide a security token based on the authentication received from the primary broker. A repository is provisioned to store at least one encryption key of the principal and transmit the encryption key to the selector upon request by the selector to decrypt a card transmitted to the selector by the primary broker.

In another embodiment, the message may include a broker password which allows access to the primary broker. The primary broker may verify the broker password. The authentication may include a selector identification and a password. This invention further features a brokered information sharing method comprising storing cards of a principal and transmitting a said card when requested by the principal, requesting cards from the broker and receiving cards transmitted from the broker; authenticating the principal, and providing a master authentication of the principal.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram showing the primary components associated with a brokered information sharing system in accordance with an example of the subject invention;

FIG. 2 is a block diagram showing the primary components associated with a typical selector depicted in FIG. 1 in accordance with the subject invention;

FIG. 3 is a block diagram illustrating the primary components associated with a typical broker depicted in FIG. 1 in accordance with the subject invention;

FIG. 4 is a block diagram depicting the primary components associated with a typical party shown in FIG. 1 in accordance with the subject invention;

FIGS. 5A-5C are data maps illustrating the origination of data elements in a selector and primary broker in accordance with the subject invention;

FIGS. 6A-6B are data maps illustrating the complete distribution of the data elements in FIGS. 5A-5C once provisioning of a selector is complete;

FIG. 7 is a flow diagram of a sequence for preparing a selector for download;

FIG. 8 is a flow diagram of a sequence for initial provisioning of a selector;

FIGS. 9A-9D illustrate exemplary data structures for requesting and returning a CAPTCHA and requesting and returning a selector i-number using the CAPTCHA;

FIGS. 10A-10B illustrate exemplary data structures for requesting and returning a selector i-number using a password;

FIGS. 11A-11B illustrate exemplary data structures for requesting and returning a selector provisioning document;

FIG. 12A-12B illustrate exemplary data structures for registering and returning a selector i-number;

FIGS. 13A-13B illustrate exemplary data structures for requesting and returning ISCP data;

FIG. 14 is a flow diagram of a sequence for selection and qualification of an OpenID identifier;

FIG. 15 is a flow diagram of a sequence for checking availability of an OpenID identifier;

FIGS. 16A-16F illustrate exemplary data structures for checking the availability of an OpenID identifier;

FIG. 17 is a flow diagram of a sequence for adding a new primary broker account and registration and provisioning of an OpenID identifier;

FIGS. 18A-18B illustrate exemplary data structures for adding a new account at a primary broker;

FIG. 19 illustrates an exemplary data structure for metadata discovery;

FIG. 20 is a flow diagram of a sequence for registration and provisioning of an OpenID identifier at a primary broker;

FIGS. 21A-21C illustrate exemplary data structures for provisioning an OpenID at a primary broker;

FIG. 22 is a flow diagram of a sequence for registration and provisioning of an OpenID identifier at an OpenID broker'

FIGS. 23A-23C illustrate exemplary data structures for provisioning an OpenID at an OpenID broker;

FIG. 24 is a flow diagram of a sequence for modifying a principal password at a primary broker;

FIGS. 25A-25C illustrate exemplary data structures for modifying a principal password at a primary broker;

FIG. 26 is a flow diagram of a sequence for modifying a principal password at an OpenID broker;

FIGS. 27A-27C illustrate exemplary data structures for modifying a principal password at an OpenID broker;

FIG. 28 is a flow diagram of a sequence for password recovery;

FIGS. 29A-29D illustrate exemplary data structures for password recovery;

FIG. 30A is a conceptual diagram of the protocol sequence for the conventional model of card selection/submission interactions between a selector, issuing party, and relying party;

FIG. 30B is a conceptual diagram of the protocol sequence of the same card selection/submission interactions as depicted in FIG. 30A with the addition of a primary broker;

FIG. 30C is a conceptual diagram of the protocol sequence of the same card selection/submission interactions as depicted in FIG. 30B with the addition of brokered authentication by the primary broker;

FIG. 31A is a flow diagram of a sequence for import of a third-party card;

FIG. 31B is a flow diagram of a sequence for creation of a principal card;

FIGS. 32A-32B illustrate exemplary data structures for adding a card to a primary broker.

FIG. 33 is a flow diagram of a sequence for selecting a card from a card wallet hosted by a primary broker;

FIGS. 34A-34B illustrate exemplary data structures for requesting a card from a card wallet hosted by a primary broker;

FIGS. 35A-35B illustrate exemplary data structures for requesting an authentication credential for a principal from a primary broker;

FIG. 36 is a flow diagram of a sequence for using knowledge-based authentication during brokered authentication; and

FIG. 37 is a conceptual diagram of the protocol sequence of the same card selection/submission interactions as FIG. 30C with substitution of using an authentication contract between the issuing party and the primary broker.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

The present invention provides a method and system for brokered information sharing between parties on a network such as the Internet. Representations of such parties on a network are commonly referred to as digital identities. The party represented by a digital identity may be an individual, an organization of any kind, a computing device of any kind, a software program or service of any kind, or any other type of entity requiring identification on a network.

In the example embodiments disclosed herein, the first party to an information sharing relationship is referred to as the principal. The second party to the relationship is referred to as either: a) the issuing party, if they are sending or publishing information that will be shared with the principal or by other relying parties selected by the principal, or b) the relying party, if they are receiving or subscribing to information published by an issuing party. An issuing party is also referred to as an “IP”, also known in the industry as an “identity provider” or “claims authority”. A relying party is also referred to as an “RP”. In addition, a party who serves to facilitate information sharing relationships between any combination of principals, issuing parties, and relying parties, but which is itself not a direct party to the information sharing relationship, is referred to as a broker.

It is an object of this invention that any party on the network operating from any device on the network may perform any or all of these roles. Apart from the technical constraints or bandwidth limitations associated with operation of a client-only device, the only limitations on a party being able to concurrently perform multiple roles are legal, business, or social constraints. Specifically, the same party that serves as a principal in some information sharing relationships may serve as the issuing party in other relationships and the relying party in still other relationships. Although brokers are not a direct party to the information sharing relationships they facilitate, a broker may separately act as a principal, issuing party, or relying party on its own behalf. In some cases information issued or received by the broker in its role as an issuing party or relying party may separately be used by the broker in its role as a broker.

Information which asserts the attributes of a digital identity, including its relationships with other digital identities, is referred to as claims. Claims have many uses but may specifically be used for authentication and authorization in a digital identity system. A group of one or more claims together with metadata describing this set of claims is referred to herein as a card. The term “card”, also referred to in the industry as “information card”, “infocard”, or “i-card”, derives both from the grouping of claims into a set and from the ability for a user interface to present this set to the principal (or other parties) using the metaphor of a physical card such as a library card, business card, driver's license card, credit card, etc. However this metaphor does not limit the actual data structure; a card may be any structured digital object capable of transferring claims, claims metadata, and other associated information between two or more parties on a network. Cards, claims, claims authorities, claims transformers, and related art are described generally in: “Personal Identification Information Schemas”, U.S. Patent Application Publication US 2007/0204325 A1, Kim Cameron and Arun Nanda, Aug. 30, 2007, incorporated by reference herein.

In a system using digital identities and cards, three types of claims play special roles: identifiers, credentials, and encryption keys.

Identifiers are used to identify different parties on the network with different properties of identification. For example, identifiers can be absolute (context-independent) or relative (context-dependent). They can be omnidirectional (publicly dereferenceable) or unidirectional (only dereferenceable in the context of a specific relationship). They can be single-part values, hierarchical segments, or multipart aggregated values. The may appear in their native form, or be hashed or encrypted. From a privacy perspective, they can be anonymous (not correlatable at all with any other identity of the principal), pseudonymous (correlatable across a limited set of other identities of the principal), or veronymous (correlatable with the principal's real-world identity). In a brokered information sharing system 100, unidirectional pseudonyms play a special role in privacy protection as further described herein.

In a wide-area network such as the Internet, the most common identifiers are IP addresses and DNS names. The World Wide Web and IETF Uniform Resource Identifier (URI) and Internationalized Resource Identifier (IRI) standards (RFC 3986 and RFC 3987 respectively) enable these network identifiers to be combined with local resource identifiers (such as filenames) to create hierarchical global identifiers. This architecture has been extended by the OASIS Extensible Resource Identifier (XRI) Technical Committee standards including “OASIS XRI Syntax 2.0”, D. Reed and D. McAlpin, Editors, http://docs.oasis-open.org/xri/xri-syntax/2.0/specs/cs01/xri-syntax-V2.0-cs.pdf, December 2005, and “OASIS XRI Resolution 2.0”, G. Wachob et al, Editors, http://docs.oasis-open.org/xri/2.0/specs/xri-resolution-V2.0.pdf, April, 2008. Global XRI registry infrastructure has been implemented by XDI.org (http://www.xdi.org) as specified in “XDI.org Global Services Specifications Version 1.0” published by XDI.org at http://gss.xdi.org.

XRIs enable expression of abstract identifiers than can be composed of other XRIs as well as URIs or IRIs. XRIs are well-suited to cross-domain information sharing because they are designed to be domain- and application-independent; they support mapping of human-friendly, reassignable identifiers (referred to as i-names) to persistent, machine-friendly identifiers (referred to as i-numbers); they provide a uniform protocol for resolution of an i-name or i-number to discovery of concrete service endpoint identifiers; and this protocol includes three trusted resolution modes for security protection (HTTPS, SAML, and HTTPS+SAML). XRI identifiers in the example embodiments disclosed in this specification use the simplified XRI syntax published in Appendix B of “The XDI RDF Model” published by the OASIS XRI Data Interchange (XDI) Technical Committee ((http://www.oasis-open.org/committees/xdi) at the permanent link http://www.oasis-open.org/committees/download.php/30955/xdi-rdf-model-v12.pdf. In this specification, identifier resolution requests that use one of the three XRI trusted resolution modes will be referred to as “XRI trusted resolution”. XRI resolution specifies an XML-based discovery document format called XRDS documents. Filtering and selection of XRDS documents for service endpoints as specified in “OASIS XRI Resolution 2.0” will be referred to herein as “service endpoint selection”.

Credentials are the claims associated with a digital identity used to authenticate the principal on the network. One of the simplest forms of credential is a password, which is typically paired with a username as an identifier for the principal. Though weak, username/password credentials are currently the most widely deployed form of authentication used on the Internet. Stronger types of credentials include one-time passwords, hardware security tokens, biometrics, and digital certificates. Even claims like legal names, postal addresses, phone numbers, SMS addresses, and email addresses can be considered a form of credential, especially with regard to password or account recovery purposes, because principals may have one or more mechanisms by which they can prove possession or control over these claims. Credentials and authentication are discussed generally in “Authentication: From Passwords to Public Keys”, by Richard E. Smith, Addison-Wesley Professional, October 2001, ISBN 978-0201615999. Encryption keys, referred to herein as “keys”, are claims associated with a digital identity that are used to encrypt and decrypt shared information. Keys may be either symmetric, where both parties to an information sharing relationship confidentially share the same key, or asymmetric, in which the combination of a public key and a private key are used together to encrypt and decrypt shared information as necessary to ensure integrity, confidentiality, authenticity, and non-repudiation. Asymmetric keys may also be shared using digital certificates of various kinds. Digital cryptography, certificates, and hashes are described generally in “Applied Cryptography, Second Edition”, by Bruce Schneier, John Wiley & Sons, 1996, ISBN 0-471-11709-9, incorporated by reference herein.

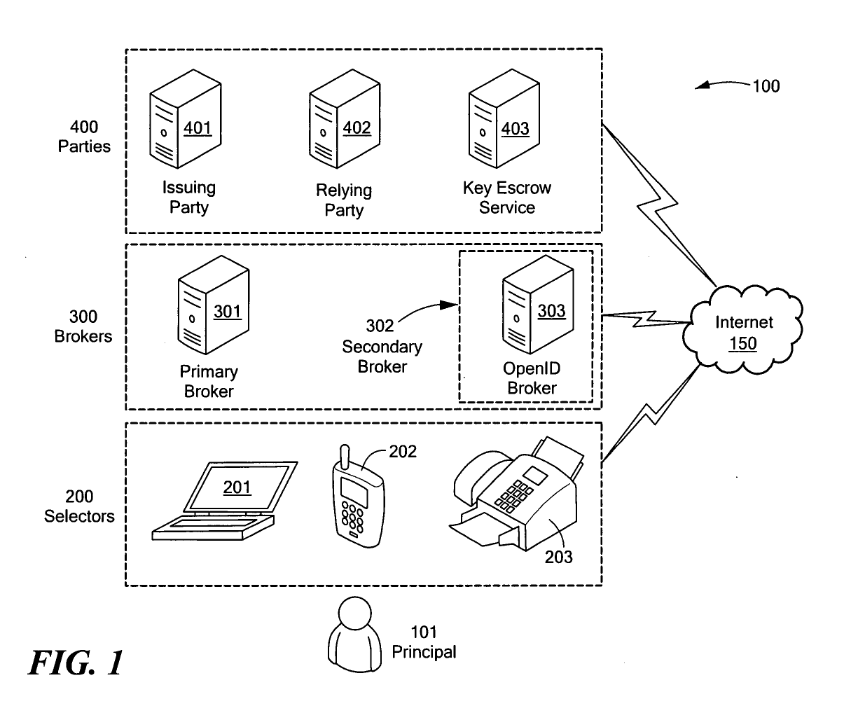

Principals which are themselves software programs are referred to as agents. Principals which are not themselves software programs, such as individuals or organizations, must use agents operating on hardware devices connected to the network to control their digital identities and information sharing relationships. In the example embodiments disclosed herein, the agents used for this purpose are referred to as selectors. FIG. 1 illustrates one example embodiment of the present invention. A brokered information sharing system 100 operating on behalf of principal 101 includes a set of selectors 200, brokers 300, and parties 400. All of these components can communicate with one another over one more networks such as the Internet 150. Such communications could also take place over the phone network, satellite networks, or any other network capable of data communications. The type of communications network is not a limiting feature of the invention.

Principal 101 communicates and interacts with the other components using selectors 200 operating on devices such as laptop computer 201, smart phone 202, and smart fax machine 203. It is an object of the present invention that a principal is not limited to using a single selector operating on a single device, but may use any number of selectors operating on any number of devices, all of which may provide access to and control of the principal's account(s) in brokered information sharing system 100.

The role of a selector is to serve as the client-side trusted agent a principal can use to select cards and control information sharing relationships. Although it may run on a server, selector 200 is typically a client software program running on a local device that communicates with servers operating online over Internet 150 or other communications networks. Selector 200 may also store a set of provisioning information, including identifiers, credentials, keys, and service endpoints, for controlling access to brokered information sharing system 100 and authenticating to brokers 300.

Information sharing relationships between principal 101 and parties 400 are facilitated by brokers 300. The role of brokers in brokered information sharing system 100 is similar to the role of bankers in a banking system. Their purpose is to serve as the server-side trusted agent of principals in information sharing transactions the same way banks serve as the trusted agent of individuals or organizations in monetary transactions. Brokers can provide data sharing messaging services that operate full time on the principal's behalf, i.e., even when client devices used by the principal are offline. Brokers may also offer data storage, search, backup, and other services that may not be available or feasible on a principal's client-side devices.

In brokered information sharing system 100, the broker with whom the principal forms their primary authentication relationship is referred to as the primary broker, shown as 301 in FIG. 1. A principal's selector is initially provisioned for an account at the principal's primary broker. However a principal may wish to receive additional identity and relationship management services from additional brokers. As a group such brokers are referred to as secondary brokers, shown as 302, FIG. 1.

One specific set of services secondary broker 302 may offer is registration, discovery, and authentication of other identifiers for a principal. The use of such identifiers may be integrated with the functions of a brokered information sharing system 100, or they may be used independently of it. One such service is OpenID authentication service as defined by the OpenID Authentication 2.0 specifications published by the OpenID Foundation at http://openid.net/specs/openid-authentication-2_{—}0.html. A secondary broker who offers OpenID authentication service is referred to as an OpenID broker, shown as 303 in FIG. 1.

As with banking, principal 101 may have a relationship with more than one primary broker 301 and more than one secondary broker 302. For example, an individual might use one primary broker for personal information sharing relationships and a separate primary broker for professional information sharing relationships. In the former case, examples primary brokers might be the individual's bank, telephone company, utility company, or ISP. In the latter case, examples primary brokers might be the individual's employer or a professional trade association. In all cases the individual's selectors may be configured to communicate with the respective brokers, much as an individual's email client software can be configured to communicate with multiple email service providers serving multiple separate email addresses. This has the advantage that the individual only needs to install, configure, and use one selector on each device to access and control all of the individual's information sharing relationships regardless of context.

Brokered information sharing system 100 enables principal 101 to easily and safely form information sharing relationships with parties 400. FIG. 1 illustrates two primary types of parties: issuing parties 401 and relying parties 402. These roles are distinguished by the directionality of their information sharing relationship with the principal as explained above. In three-way information sharing relationships, each party plays only one role: the issuing party issues the shared information, the principal selects the information to be shared and the relying party with which to share it, and the relying party receives the shared information.

In two-way information sharing relationships, the principal also plays the role of the issuing party. For example, if Alice wants to share one of her own business cards with Bob, Alice is playing the role of both the principal and the issuing party, and Bob is playing the role of the relying party. Even if Bob initiates the transaction by requesting a business card from Alice, Alice still plays the role of the principal, since she controls the selection of the information to be shared and the relying party with whom to share it. Two principals may of course have reciprocal information sharing relationships, i.e., after Alice shares her business card with Bob, Bob acting as his own principal and issuing party may reciprocate by sharing his business card with Alice as a relying party.

In this specification cards are referred to from the perspective of the principal. A card issued to a principal by another issuing party is referred to as a third-party card. A card for which the principal is the issuing party is referred to as a principal card. In the IMI specifications a third-party card is called a “managed card” and a principal card is called a “personal card”.

With the proper permissions, information shared with a relying party may also be republished by that relying party as another issuing party. For example, Alice as an issuing party may share her street address with her telephone company as a relying party. Her telephone company as an issuing party may in turn republish that information to an online phone directory as a relying party. The present invention enables the chain-of-authority for such multi-party information sharing relationships to remain clear and unambiguous, providing greater control, auditability, and accountability for all parties.

With the proper permissions, information shared with one relying party may also be forwarded to another relying party. For example, Alice may give Bob permission to forward her business card to Bob's friend Charles. In this example Alice, not Bob, remains the issuing party. Bob is referred to as the forwarding party.

Parties 400 may also serve as service providers to principal 101. FIG. 1 illustrates one example, a key escrow service 403 that acts as relying party 402. A key escrow service plays a special role in brokered information sharing system 100 because protection of a principal's data stored at or transferred via a broker is as vital as protection of an account holder's money stored in or transferred through a bank. Just as banks are subject to many sources of attack due to the value of the money they hold, so too are brokers for the value of a principal's data and credentials. For example, external attackers may try to gain unauthorized access by breaking through network firewalls or other perimeter defenses. Internal or “insider” attacks are perpetrated by employees or contractors who have administrative privileges to the broker's systems and use those privileges to gain unauthorized access to a principal's data. For a broker, such attacks may pose even greater business risk than for a banker because once outsiders or insiders gain access to identity and relationship data, they are in a position to impersonate the principal and cause even greater damage. The more unblinded information a principal stores at a broker, the more such information may become a “honey pot” for attackers.

Data blinding at the broker may be accomplished by encrypting the data at the selector. However if the selector is the only source of the encryption keys and other provisioning information, loss of the selector (either through physical loss of the device, or malfunctioning of the hardware or software) and/or loss of the credentials needed to authenticate the selector to the broker can result in catastrophic loss of the account and the shared information.

It is therefore important to have a method for safely recovering access to a principal's broker account(s) no matter what form of credential, key, or selector loss principal 101 may suffer. One such method is for principal 101 to use the services of key escrow service 403 as relying party 402 as further described herein.

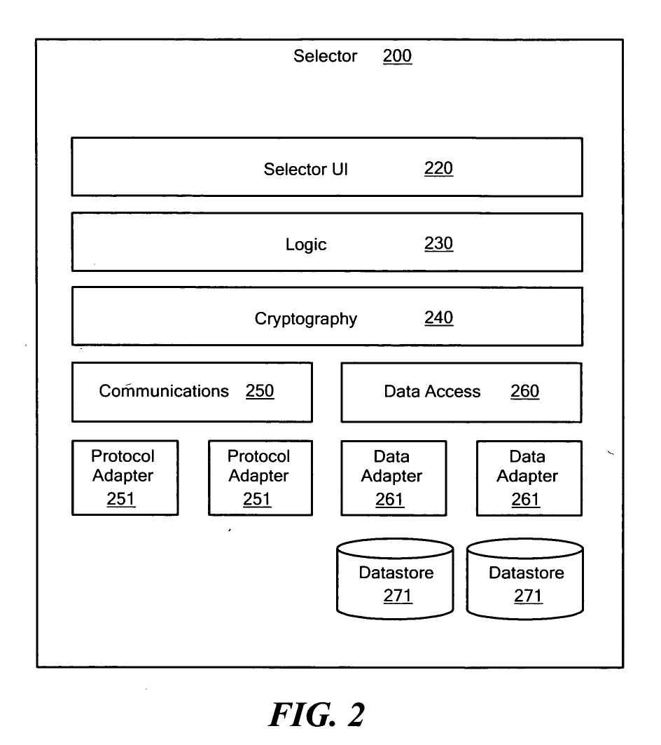

A typical selector program 200, FIG. 2, includes selector UI (user interface) module 220, logic module 230, cryptography module 240, communications module 250, data access module 260, and datastores 271.

Selector UI module 220 is responsible for displaying screens, menus, cards, data, and information sharing relationships to the principal and accepting input from the principal to control and manage the principal's information sharing relationships. Selector logic module 230 is where the processing logic of the selector is executed to trigger the display of screens, sending of messages, reading/writing of data, or performance of other actions needed to carry out the functions of the selector.

Selector cryptography module 240 is called by other modules when data encryption, decryption, verification, and other cryptographic services are required. With respect to the generation and transformation of security tokens such as those related to cards in protocols such as WS-Trust, this module is sometimes referred to as a “security token service” or “STS”. The current WS-Trust V1.3 specification, published by the OASIS Web Services Secure Exchange Technical Committee, is available at the link http://docs.oasis-open.org/ws-sx/ws-trust/200512/ws-trust-1.3-os.html. In a preferred embodiment, cryptography module 240 is configured to communicate securely with a similar security module that is part of the operating system of the device, such as the Microsoft Cryptograph API (MSCAPI) in the Microsoft Windows® operating system. Such security can be further hardened by use of a trusted hardware security module such as the Trusted Platform Module whose specifications are defined by the Trusted Computing Group at https://www.trustedcomputinggroup.org/specs/TPM/.

Selector communications module 250 is called by other modules to send and receive messages that need to be delivered over communications protocols relevant to the selector's functions. In a preferred embodiment, the communications module performs these functions by calling protocol modules 251 that handle the specific details of particular communications protocols. Besides WS-Trust, the example embodiments discussed herein may involve the HTTP, HTTPS, and XDI protocols. The HTTP protocol specification, published as RFC 2616 by the Internet Engineering Task Force (IETF), is available at http://tools.ietf.org/html/rfc2616. The HTTPS protocol, published as IETF RFC 2818, is available at http://tools.ietf.org/html/rfc2818. The XDI protocol, published of the OASIS XRI Data Interchange (XDI) Technical Committee, is a work-in-progress described in the aforementioned “The XDI RDF Model”. However in a preferred embodiment, brokered information sharing system 100 is extensible to support any type of protocol that may be used to transfer data, credentials, tokens, or cards.

Selector data access module 260 is called when the selector needs to read or write data from local datastores. In a preferred embodiment, the selector uses a data abstraction layer in which data access module 260 calls different data adapters 261 to read/write data from any type of datastore 271. Such a data abstraction layer is provided by the open source Higgins Project, a project of the Eclipse Foundation available at http://www.eclipse.org/higgins/. This data abstraction layer may be used on either clients and servers to make data available via a uniform API (application programming interface) and data model called the Context Data Model (CDM). On a client device, such a data abstraction layer enables a selector to read and write data from local datastores such as the Linux, Apple Macintosh®, or Microsoft Windows® file systems; local directories system such as the Windows Registry; local applications such as Mozilla Thunderbird, Microsoft Outlook®, or Microsoft Excel®; or local databases such as MySQL or Microsoft Access®. Such datastores may use application-specific data schemas, or they may use a context-independent schema such as the RDF (Resource Description Framework) defined by the World Wide Web Consortium's Semantic Web activity (http://en.wikipedia.org/wiki/Semantic_Web) or the XDI RDF model defined by the OASIS XDI Technical Committee. In particular the aforementioned document “The XDI RDF Model” specifies a compact serialization format for XDI RDF documents called X3. Several X3 variants are specified for different purposes: X3 Standard for compact over-the-wire transmissions; X3 Whitespace for human-readable display; and X3 Simple for human-readable/writeable display. The example XDI RDF documents disclosed herein use the X3 Simple format. In such example documents, all values enclosed in squiggly brackets, e.g., {selector-i-number}, are placeholders for the actual values used in real instances. In a preferred embodiment selector 200 is integrated with a principal's Internet browser and with other communications software that may run on a device such as an email client, instant messaging client, VoIP client, etc. Selector 200 can operate entirely as a plug-in module, or as a combination of a plug-in and a standalone program, or entirely as a standalone program, or any combination as best suits the operating system, security requirements, and user preferences.

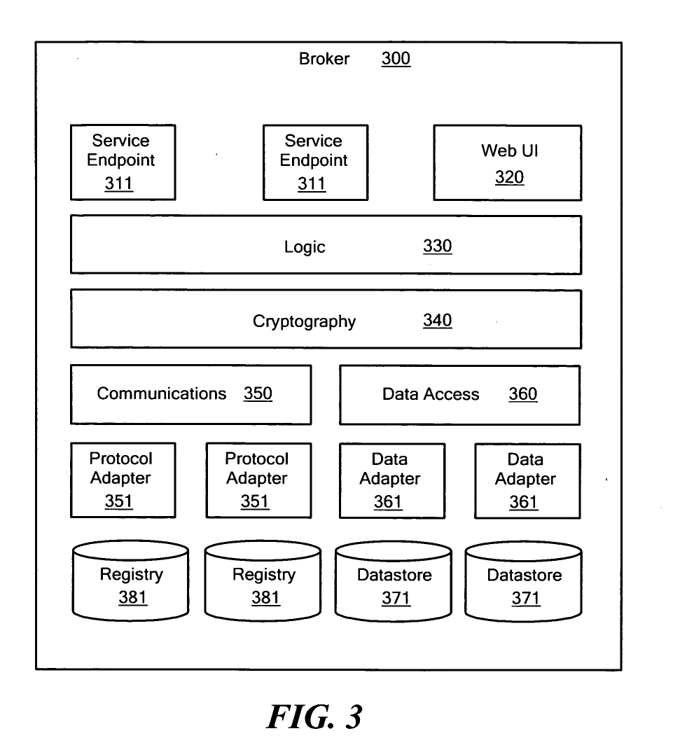

Broker subsystem 300, FIG. 3, typically includes service endpoints 311, web UI module 320, logic module 330, cryptography module 340, communications module 350, data access module 360, datastores 371, and registries 381. All of these modules perform substantially the same functions as the corresponding modules in selector 200 with the exception of service endpoints 311, the web UI 320, and the registries 381.

Service endpoints 311 are the server-side complement of protocol adapters 251 in FIG. 2. They handle protocol messages received by broker 300, FIG. 3, route them to other modules as required for processing, and send the corresponding response as required. The network location and any other essential communications characteristics of a service endpoint are described in a discovery document accessible via a discovery protocol used by components of brokered information sharing system 100 as further described herein.

Web UI module 320 is responsible for display of web pages that provide a browser-accessible user interface for the broker. The present invention is not limited to a web UI; a client-server UI or any form of UI that provides principals with direct access to the functions of a broker when required could also be implemented. The broker UI is not a limiting feature of the invention.

Registries 381 are a specialized form of datastore optimized for storage and indexing of identifiers and discovery metadata describing principals and other parties in brokered information sharing system 100. Such registries may be implemented under a data abstraction layer, such as Higgins as described above, or they may be implemented separately. Such identifiers may be an OpenID identifier as defined by the OpenID Authentication 2.0 specification published by the OpenID Foundation, available at http://openid.net/specs/openid-authentication-2_{—}0.html. OpenID identifiers include URIs conforming to the URI specification, published by the IETF as RFC 3986 available at http://tools.ietf.org/html/rfc3986, and XRIs conforming to the aforementioned “XRI Syntax V2.0” specification published by the OASIS XRI Technical Committee, or any other form of identifier which provides the identification and discovery properties required of brokered information sharing system 100 as described herein. Such discovery metadata may include data elements defined for XRDS discovery documents as defined by the aforementioned “XRI Resolution V2.0” specification published by the OASIS XRI Technical Committee, SAML metadata documents as defined by the “Metadata for the OASIS Security Assertion Markup Language (SAML) V2.0” specification published by the OASIS Security Services Technical Committee at http://docs.oasis-open.org/security/saml/v2.0/saml-metadata-2.0-os.pdf, WS-SecurityPolicy documents as defined by the “WS-SecurityPolicy V1.2” specification published by the OASIS Web Services Secure Exchange Technical Committee available at http://docs.oasis-open.org/ws-sx/ws-securitypolicy/200702/ws-securitypolicy-1.2-spec-os.html, or any other discovery or metadata exchange protocol that may be integrated into brokered information sharing system 100. In a preferred embodiment XRIs are used with XRI trusted resolution to retrieve XRDS documents.

The use of data access module 360 and, in a preferred embodiment, a data abstraction layer, such as Higgins can be employed by a broker to provide access to different back-end datastores such as LDAP directories, relational or object-oriented databases, in-memory databases, data warehouses, or other data repositories as needed to meet the broker's requirements for security, performance, reliability, scalability, and storage of different data types.

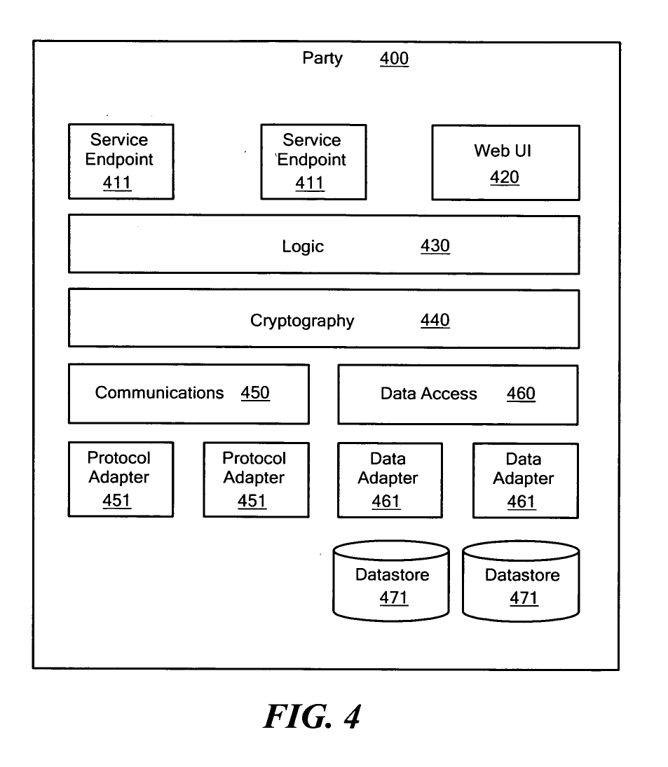

An example of party 400, FIG. 4, includes service endpoints 411, web UI module 420, logic module 430, cryptography module 440, communications module 450, data access module 460, and datastores 471. All of these modules perform substantially the same functions relative to a party as the corresponding modules in broker 300 with the exception that a party may not need registry 381.

Although they serve different roles, the basic components of party 400 are the same for both issuing parties 401 and relying parties 402. The differences in how these parties employ these components are further described herein.

In one example, to create and manage information sharing relationships in brokered information sharing system 100, FIG. 1, principal 101 must first obtain at least one selector 200 and provision it with the identifiers, credentials, and keys necessary to communicate with at least one primary broker 301. In a preferred embodiment, this is accomplished using a protocol called ISCP (Identity Service Configuration Protocol). This protocol uses XRIs for digital identifiers, XRI trusted resolution and XRDS documents for service endpoint discovery, and XDI structured data sharing to distribute the necessary data elements between selector component 200, primary broker 301, and any secondary brokers 302.

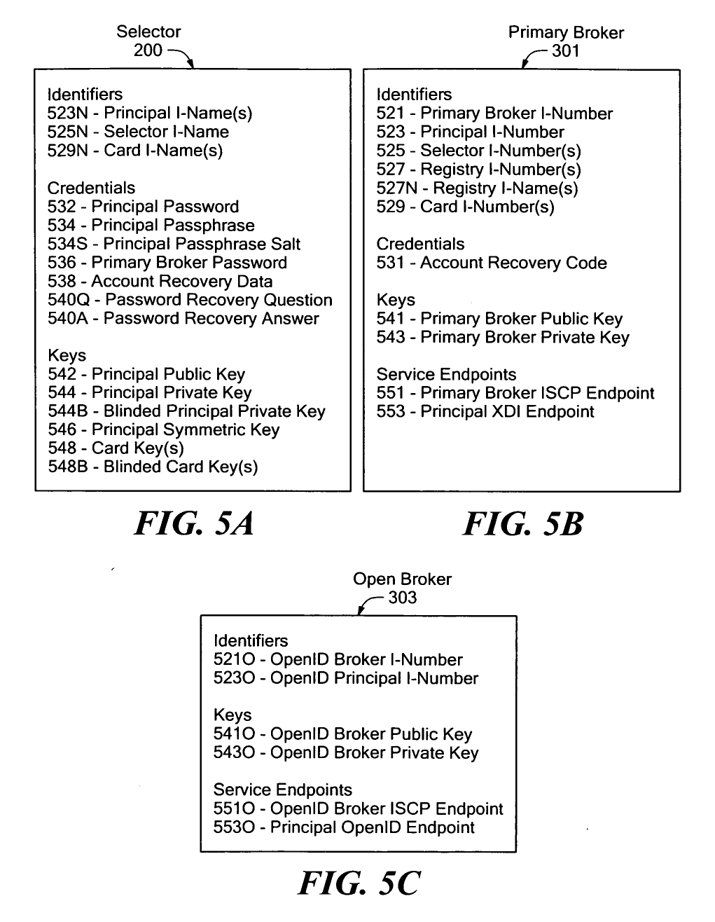

FIG. 5 is a block diagram illustrating the origination of the identifiers, credentials, keys, and service endpoints, collectively referred to herein as provisioning information, which the ISCP protocol is used to distribute and manage.

The provisioning information originating at selector 200, FIG. 1 (or input by the principal 101) includes principal i-name(s) 523N, FIG. 5A, selector i-name 525N, card i-name(s) 529N, principal password 532, principal passphrase 534, principal passphase salt 534S, primary broker password 536, account recovery data 538, password recovery questions 540Q, password recovery answers 540A, principal public key 542, principal private key 544, blinded principal private key 544B, principal symmetric key 546, card key(s) 548, and blinded card key(s) 548B.

The provisioning information originating at primary broker 301, FIG. 1, includes primary broker i-number 521, FIG. 5B, principal i-number 523, selector i-number(s) 525, registry i-numbers 527, registry i-names 527N, card i-numbers 529, account recovery code 531, primary broker public key 541, primary broker private key 543, primary broker ISCP endpoint 551, and principal XDI endpoint 553.

The provisioning information originating at an OpenID broker 303, FIG. 1, includes OpenID broker i-number 521O, FIG. 5C, OpenID principal i-number 523O, OpenID broker public key 541O, OpenID broker private key 543O, OpenID broker ISCP endpoint 551O, and principal OpenID endpoint 553O.

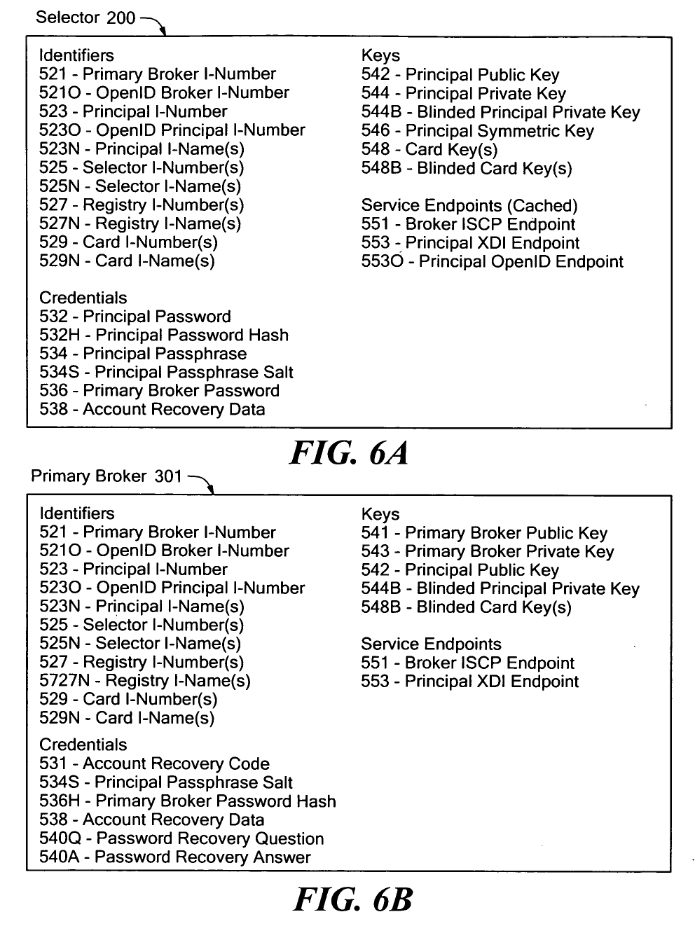

FIGS. 6A-6C are block diagrams illustrating the distribution of provisioning information once the operations of the ISCP protocol are complete for any particular instance of selector 200, FIG. 1, provisioned for an account at primary broker 301. A comparison of FIGS. 5 and 6A-6C produces an inventory of the claims the ISCP protocol is responsible for replicating between these two components of brokered information sharing system 100 as further described herein.

The ISCP protocol uses three types of identifiers for a principal 101: principal i-name 523N, principal i-number 523, and OpenID principal i-number 523O. Principal i-name 523N identifying principal acting within an individual context begins with the XRI global context symbol =. This may be either a global i-name, for example =example.name, or a community i-name, for example =community*example.name. A principal i-name 523N identifying a principal acting within an organizational context begins with the XRI global context symbol @. This too may be either a global i-name, for example @example.name, or a community i-name, for example @community*example.name.

A principal may register more than one principal i-name 523N, and all such i-names may act as synonyms for the same public principal i-number 523. Principal i-name 523N may be used by the principal at any site or application that accepts an XRI for purposes of identifying the principal and resolving an associated service discovery document such as an XRDS document. An example is the use of XRIs for site-independent authentication of principals as described in OpenID Authentication 2.0 specification published by OpenID Foundation at http://openid.net/specs/openid-authentication-2_{—}0.html.

When principal i-name 523N is registered, in a preferred embodiment, the associated XRI registry will automatically assign a synonymous public principal i-number 523. This is a persistent XRI that will never be reassigned by the registry, and thus can be safely used to identify the principal in brokered information sharing system 100 without the security issues associated with reassignable identifiers as described in “OpenID Discovery with XRI and XRDS”, a paper presented at the 2008 IDTrust Symposium published by the Association for Computing Machinery at http://middleware.internet2.edu/idtrust/2008/papers/01-reed-openid-xri-xrds.pdf.

The synonymous i-number for a global i-name is a global i-number, for example =!2a56.43dc.f892.22b9 for a principal acting within an individual context or @!723d.12ac.9e00.4506 for an principal in an organizational context. The synonymous i-number for a community i-name is a community i-number, for example =!bc52.5a73.df8a.c3d6!4871.3bac.404d.f5a5 for a principal in an individual context or @!723d.12ac.9e00.4506!d3ac.49c7.dfae.2a03 for a principal acting within an organizational context.

OpenID principal i-number 523O is the i-number used to identify principal 101 in the context of a specific OpenID broker 303. If principal's primary broker 301 is also principal's OpenID broker 303, then principal i-number 523 and OpenID principal i-number 523O may be (but are not required to be) identical. Otherwise, OpenID principal i-number 523O will be assigned in the context of the registry i-number 527.

For the purposes of the ISCP protocol, all participating OpenID identifier registries are identified using registry i-number 527 and at least one registry i-name 527N. This applies even if OpenID registry assigns http: or https: URIs as OpenID identifiers; from the standpoint of the ISCP protocol these identifiers are all synonyms of OpenID principal i-number 523O.

Although brokers 300 may also have both i-names and i-numbers, the ISCP protocol uses only i-numbers to identify brokers: primary broker i-number 521 and OpenID broker i-number 521O. An example broker i-number is @!af83.62b1.441f.2813. The ISCP protocol uses two identifiers for selectors 200 that are used by principals 101 to interact with brokered information sharing system 100: selector i-number 525 and selector i-name 525N. Although any resolvable identifier may be used for a selector i-number 525, in a preferred embodiment it is a persistent XRI composed of two parts: primary broker i-number 521 plus a local i-number assigned by primary broker 301 to represent the locally unique identity of selector 200 as an agent. An example selector i-number is @!af83.62b1.441f.2813!ef43.3012.d9a0.bb47, where @!af83.62b1.441f.2813 is primary broker 301 i-number and !ef43.3012.d9a0.bb47 is the local i-number representing the selector.

Selector i-name 525N is a human-friendly identifier assigned by principal 101 so principal 101 can distinguish between selectors in ISCP operations. In a preferred embodiment, selector i-name 525N, like principal i-name 523N, is a reassignable XRI that supports UTF-8 encoding for internationalization. Example selector i-names 525N in English are Family Desktop, Mary Laptop, iPhone, and Home Fax Machine.

The ISCP protocol also uses two identifiers for cards: card i-number 529 and card i-name 529N. As with selector i-number 525, in a preferred embodiment, card i-number 529 is a persistent XRI composed of two parts: registry i-number 527 plus a local i-number assigned by primary broker 301 to represent the locally unique identity of the card. An example card i-number is =!bc52.5a73.df8a.c3d6!82d2.fbc3.142e.5d25, where =!bc52.5a73.df8a.c3d6 is the registry i-number and !82d2.fbc3.142e.5d25 is the local i-number representing the card.

The ISCP protocol uses six types of credentials for principal 101: principal password 532, principal passphrase 534, primary broker password 536, account recovery data 538, password recovery question 540Q, and password recovery answer 540A. Other credentials may be used for stronger forms of authentication as further described herein.

Principal password 532 may be any form of password for the principal that satisfies the relevant security policies. If a password string is used, in a preferred embodiment, it satisfies a password strength meter or test administered by the selector or primary broker (depending on the initial point of entry) to ensure it meets the relevant security policies. In alternate embodiments a pictographic password, biometric password, or other form of authentication credential may be used. The particular form or strength of the credential used as principal password 532 is not a limiting feature of the invention.

Principal passphrase 534 may be any form of seed material suitable for generation of a cryptographic key for use by selector 200 on behalf of principal 101 and for transcription by principal between selectors as needed. It may be automatically generated by selector 200, or manually entered by the principal. In the latter case, in a preferred embodiment, the selector UI includes a passphrase strength meter or test to ensure it meets the relevant security policies. The particular form or strength of principal passphrase 534 is not a limiting feature of the invention.

In a preferred embodiment, primary broker password 536 is a complex value composed by concatenating principal password 532 and principal passphrase 534 and then hashing the resulting string. This binding supports desired password recovery and account recovery properties as further described herein. Any sufficiently strong secure hash function, such as MD5, SHA-1, or the SHA-2 family may be used since only selector 200 needs to be able to calculate the hash.

The purpose of account recovery data 538 is to serve as another set of credentials that enable primary broker 301 to authenticate principal 101 in case of password loss or complete selector loss. In a preferred embodiment, account recovery data includes the principal's legal name, legal address, email address(es), SMS address(es). Other potential types of account recovery data 534 will be apparent to those skilled in the art. The particular types of account recovery data 534 are not a limiting feature of the invention.

Password recovery question 540Q and the paired password recovery answer 540A are used as a second authentication factor in password recovery. An example of each is “What was your best friend's favorite hobby?” and “anthills”. They are used in conjunction with an account recovery code 531, a token delivered to principal 101 to authenticate that the principal controls the communications channels represented by the account recovery data 538. This token take any form necessary to meet the security and usability requirements. An example account recovery code is 7D84-9KFW-43NB-29GY-HCRA.

For brokers, in one embodiment, the ISCP protocol uses conventional X.509 certificates as credentials. These certificates contain primary broker i-number 521 or OpenID broker i-number 521O, as applicable.

The ISCP protocol uses four types of keys on behalf of principal 101: principal public key 542, principal private key 544, principal symmetric key 546, and card key(s) 548. In addition it also uses a blinded principal private key 544B and blinded card key(s) 548B.

Principal public key 542, principal private key 544, principal symmetric key 546, and card key(s) 548 are generated by selector cryptography module 240, using software libraries designed for this purpose according to the algorithms and formats specified by the ISCP protocol. In a preferred embodiment, RSA 2048-bit keys are used for public/private key pairs and AES 256-bit keys for symmetric keys. Key generation is discussed generally in the aforementioned “Applied Cryptography, Second Edition”. In a preferred embodiment this routine is implemented so that it requires little or no waiting on the part of principal 101. These keys are used for encrypting data stored at primary broker 301 or sent to relying parties 402, as further described herein.

Blinded principal private key 544B, and blinded card key(s) 548B are, respectively, principal private key 544 and card key(s) 548 encrypted by selector cryptography module 240 with principal symmetric key 546 for back storage at primary broker 301.

For brokers, the ISCP protocol uses conventional public/private key pairs: primary broker public key 541 and primary broker private key 543 for primary broker 301 and OpenID broker public key 541O and OpenID broker private key 543O for OpenID broker 303. In a preferred embodiment, these are RSA 2048-bit keys. The X.509 certificates corresponding to these public keys can be discovered from the broker's XRDS documents using XRI trusted resolution.

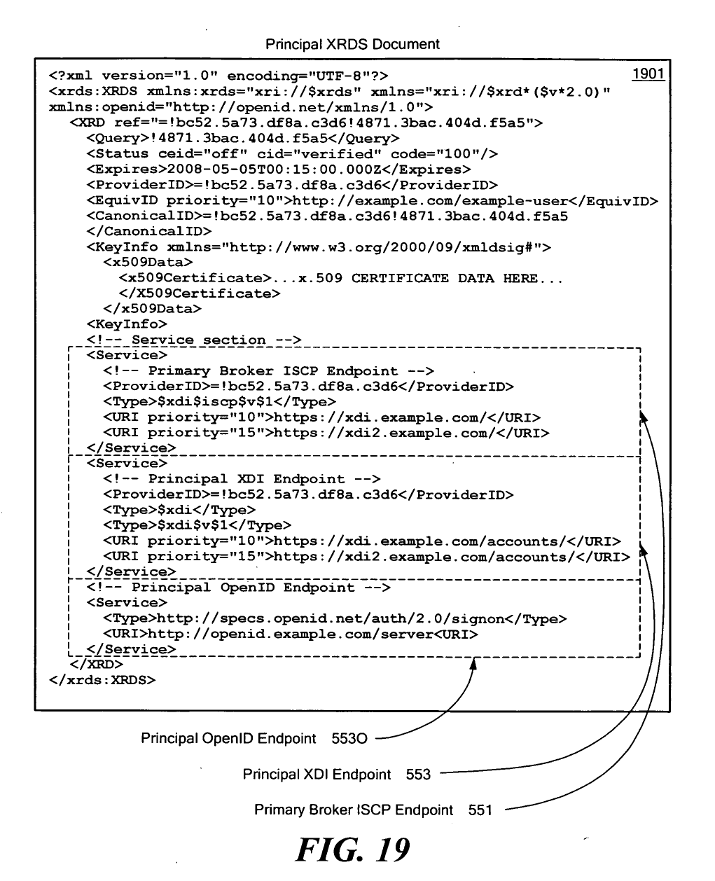

The ISCP protocol uses two service endpoints (SEPs) to represent principal 101: principal XDI endpoint 553 and principal OpenID endpoint 553O. It also uses one SEP to represent each broker: primary broker ISCP endpoint 551 and OpenID broker ISCP endpoint 551O. Examples of these service endpoints are shown in the principal XRDS document 1901 in FIG. 19. Technical details of XRDS document structure, resolution, and service endpoint selection are in the aforementioned “XRI Resolution 2.0” specification.

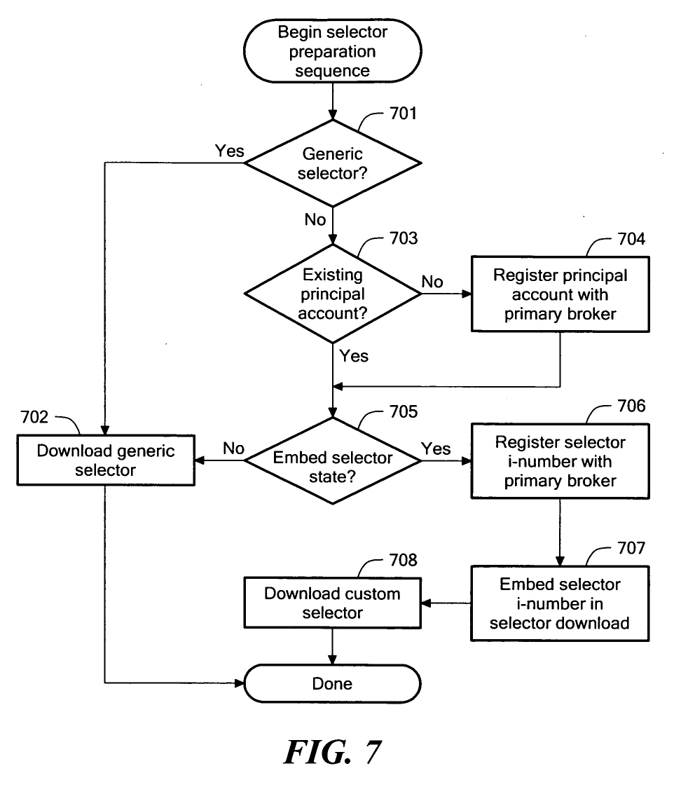

Selector 200, FIG. 1, may be pre-installed on a device or it may be downloaded to the device by principal 101. In the latter case, FIG. 7 is a diagram depicting the primary steps associated with preparing selector 200 for downloading. The first decision in step 701 is whether principal will download a generic selector irrespective of having established an account with primary broker 301. If so, in step 702 principal may proceed directly with a generic download; account creation if necessary will take place entirely from selector using ISCP. Step 703 is a test of whether principal has an existing account with primary broker 301. If not, in step 704 principal registers an account with primary broker 301 in which principal selects a principal i-name 523N and principal password 532 and is assigned a principal i-number 523. Step 705 is a test of whether selector download will be customized by embedding state information, such as selector i-number 525 or an associated index value that associates a selector provisioning document, referred to as an SPD, at primary broker 301. If so, in step 706, selector i-number 525 is registered with primary broker 301. In step 707, the state information is embedded in selector download. In a preferred embodiment, it is embedded within the contents of the download file, however it may also be encoded in the download filename, associated with the web page from which the download is performed, or any other means of securely transferring this state information. The flow concludes with the download of the customized selector in step 708.

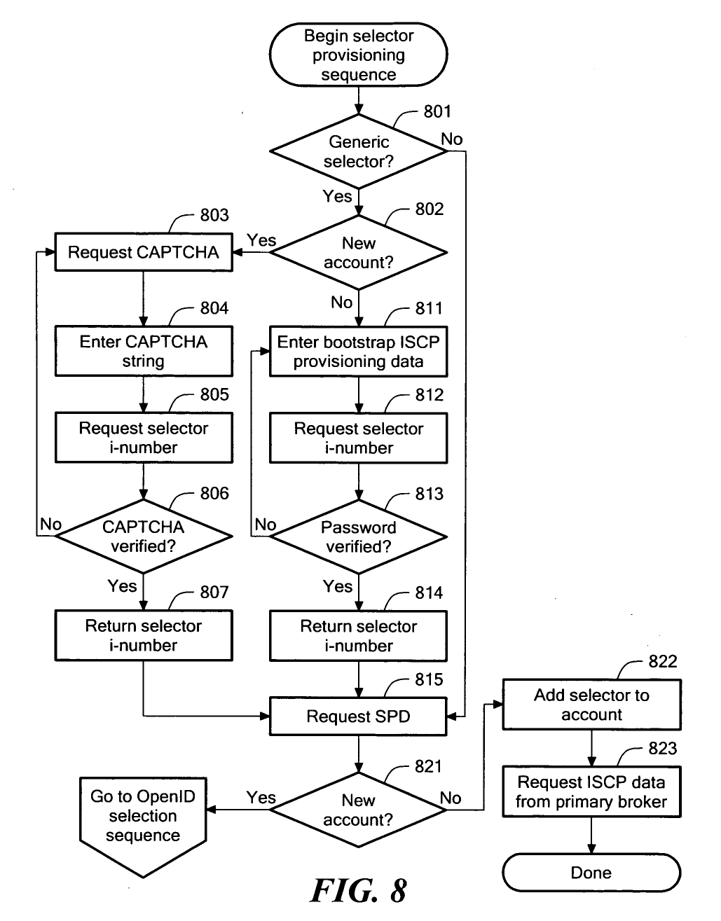

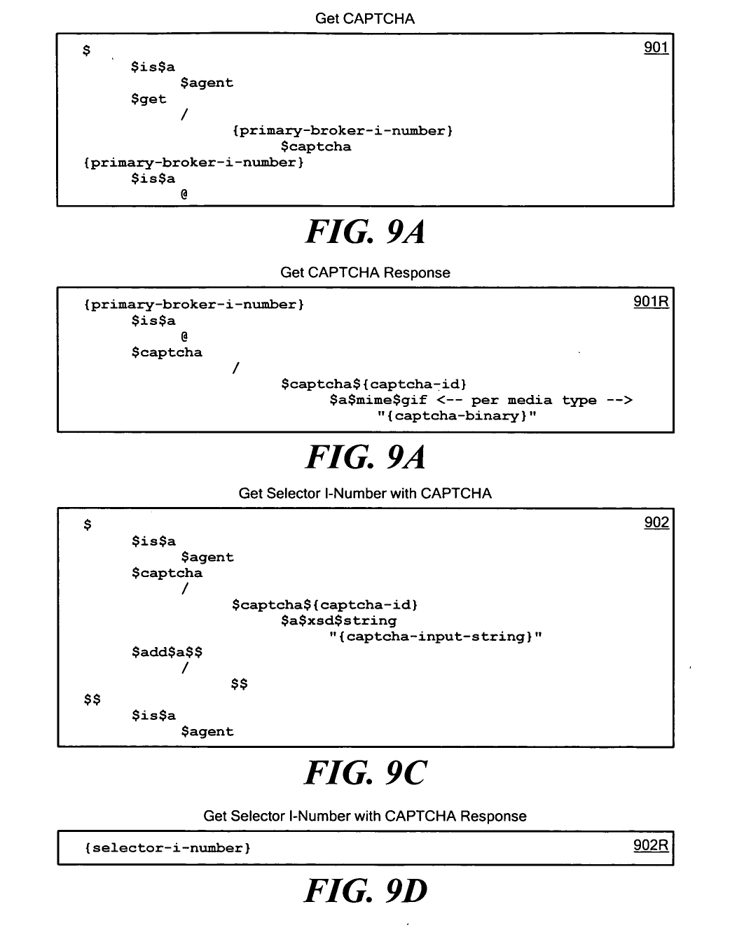

FIG. 8 is a flow diagram showing primary initial bootstrap provisioning steps taken after a new selector 200 is installed. These steps apply whether selector was downloaded or was already installed and shipped directly with the host device. In step 801, selector 200, FIGS. 1-2, tests to see whether state information is embedded or whether it is generic. If it is not generic, selector 200 can skip directly to step 815, FIG. 8, below. If it is generic, in step 802 selector UI module 220, FIG. 2, prompts principal 101, FIG. 1, to indicate whether principal wishes to create a new primary broker account or use an existing account. If it is a new account, in step 803, FIG. 8, selector 200 communications module 250 requests a CAPTCHA from primary broker 301 by sending the Get CAPTCHA message 901, shown in FIG. 9A to the HTTPS URI of the primary broker. This URI is hard coded into the selector download. Since this is the first communication between selector 200 and primary broker 301, selector 200 also verifies the SSL certificate of the primary broker to ensure it is authentic. Primary broker 301 responds with the Get CAPTCHA response message 901R, FIG. 9B. In Step 804, FIG. 8, selector UI module 220, FIG. 2, displays the CAPTCHA to principal and requests entry of the CAPTCHA string in order to ensure principal is a human and to prevent robot-driven registrations. In step 805, FIG. 8, selector communications module 250 uses this input to send the ISCP Get Selector I-Number with CAPTCHA message 902, FIG. 9C, to primary broker 301. Since selector 200 has not yet been assigned a selector i-number 525, the selector identifies itself using the XDI $ (self) subject. In step 806, FIG. 8, primary broker 301 verifies the CAPTCHA input string. If it does not verify, the primary broker returns an XDI error message and the selector must loop back to step 803. If it does verify, in step 807 the primary broker executes the XDI $add$a$$ operation ($$ represents an XDI variable that is assigned by the message recipient) by registering a new selector i-number 525 and returning it in the Get Selector I-Number with CAPTCHA Response message 902R, FIG. 9D.

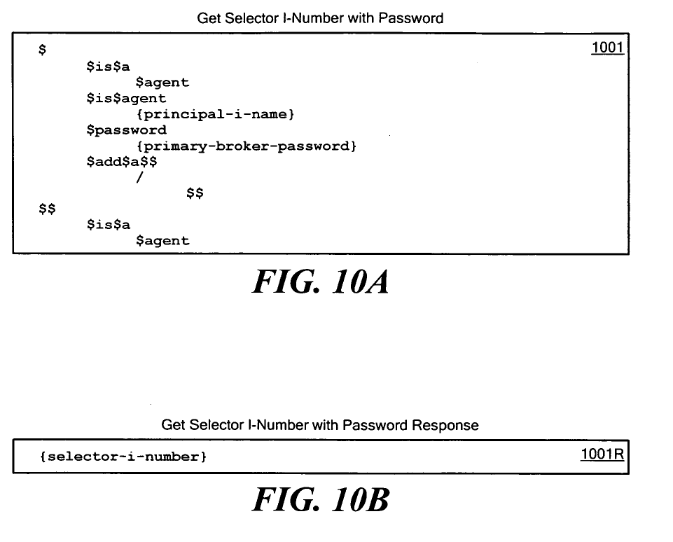

If principal 101 elects to use an existing account in step 802, FIG. 8, in step 811 selector UI module 220, FIG. 2, prompts principal 101 to enter the provisioning data necessary to bootstrap ISCP. This includes the principal i-name 523N, principal password 532, principal passphrase 534, and a selector i-name 525N assigned by principal to identify this particular selector. Selector 200 then composes primary broker password 536 by concatenating principal password 532 and principal passphrase 534 and creating a hash of the result. In step 812, FIG. 8, selector 200 sends the Get Selector I-Number with Password message 1001, shown in FIG. 10 to primary broker 301. Since selector 200 has not yet been assigned a selector i-number 525, selector 200 identifies itself using the XDI $ subject, but this time it includes the $a$agent predicate with principal i-name 523N as the XDI object. This identifies principal account with which principal password 532 (the object of the $password predicate) is associated. In step 813, FIG. 8, primary broker 301 verifies the supplied principal password 532 against the stored password for this account. If it does not verify, primary broker 301 returns an XDI error message and selector 200 must loop back to step 811. If it does verify, in step 814, primary broker 301 registers a new selector i-number 525 and returns it in the Get Selector I-Number with Password Response message 1001R.

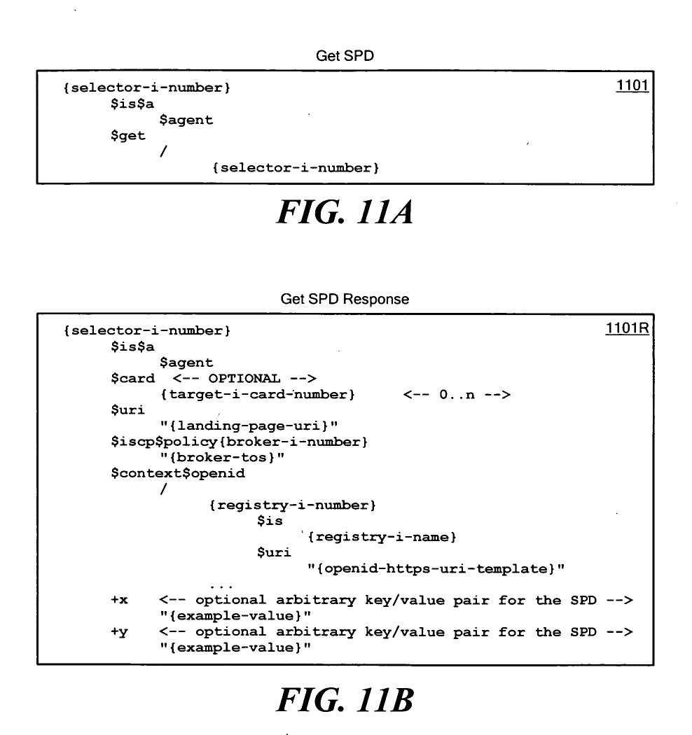

Now that selector 200 has been provisioned with selector i-number 525, in step 815, FIG. 8, it sends Get SPD (Selector Provisioning Document) message 1101, FIG. 11A, to primary broker 301. If this is the first communication with primary broker 301, selector 200 verifies the primary broker's SSL certificate as described above. Since this message does not reveal any sensitive information, primary broker 301 need only verify that the message originates from a valid selector i-number 525. Primary broker 301 then returns Get SPD Response message 1101R, FIG. 11B. This message contains the Selector Provisioning Document with the rest of the selector state information necessary to complete ISCP provisioning. For example, the $card predicate identifies zero-or-more target cards to be imported into the principal's account once ISCP provisioning is complete. The $uri predicate identifies exactly one target landing page for the principal's browser once ISCP provisioning is complete. The $iscp$policy{broker-i-number} predicate is the terms-of-service the primary broker offers for opening of a new account. The $context$openid predicate contains an XDI subgraph with entries for one-or-more OpenID registries for whom primary broker 301 serves as an OpenID registrar. The entry for each registry includes registry i-number 527, synonymous registry i-name 527N, and a template for expressing XRIs in that registry as https: URIs for backwards compatibility with OpenID relying parties that do not yet support XRI identifiers. Finally, as indicated by the +x and +y predicates, the SPD is extensible to include any other XDI predicates, object, and subgraphs necessary to customize a selector as desired by a primary broker or its affiliates.

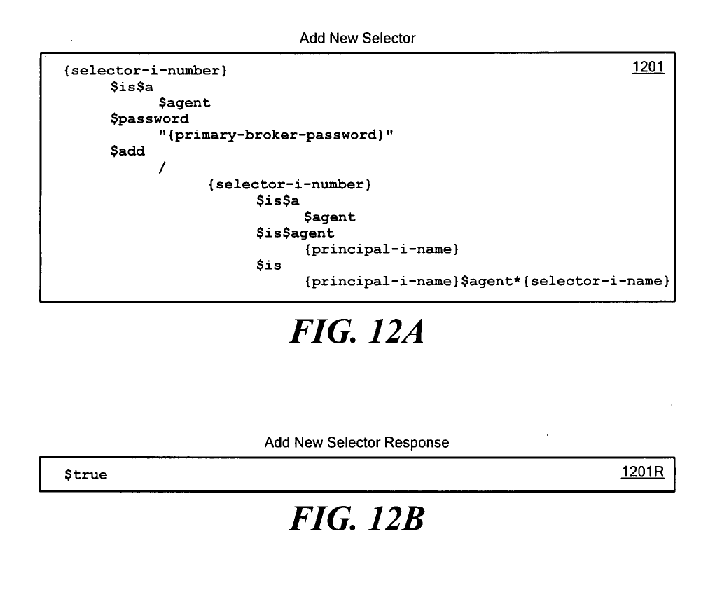

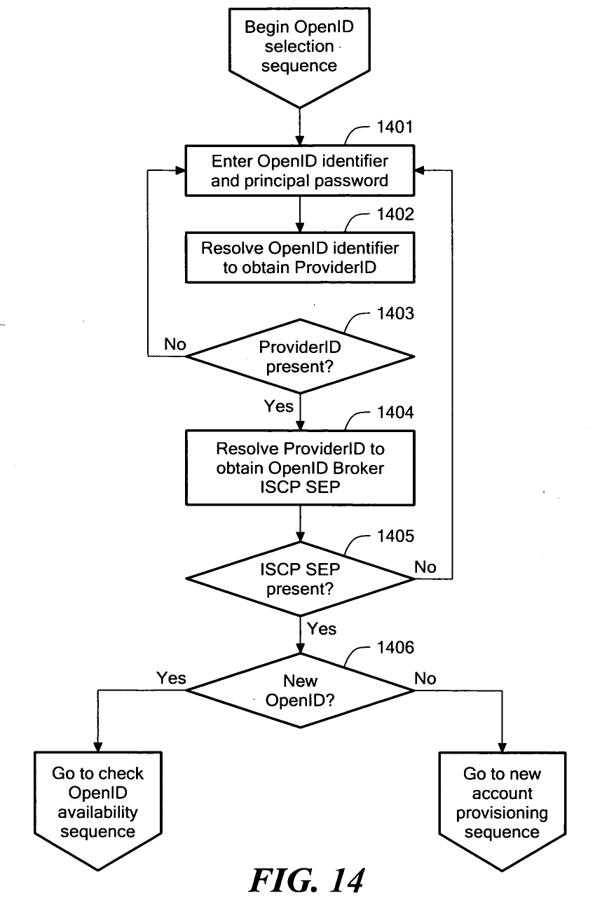

In step 821, FIG. 8, selector 200 again branches depending on whether principal 101 desires to open a new account or use an existing account. For a new account, selector 200 proceeds to OpenID selection sequence as illustrated in FIG. 14. For an existing account, in step 822, FIG. 8, selector 200 sends the Add New Selector message 1201, FIG. 12A, to primary broker 301. This registers the selector i-number 525 and the selector i-name 525N to the primary broker account represented by the principal i-name 523N. If successful, the primary broker returns the Add New Selector Response message 1201, FIG. 12B. If an error is returned, an XDI $false response, selector 200 processes the error and prompts the principal 101 to correct it.

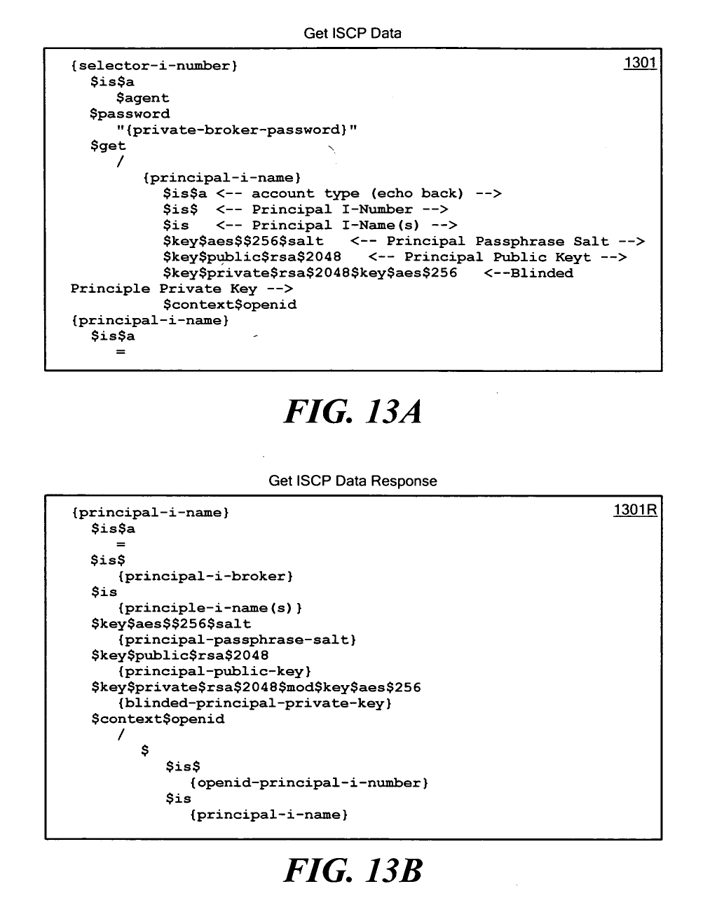

Having registered a new selector i-number 525 to the principal's primary broker account, in step 823, FIG. 8, selector 200 communications module 250, FIG. 2, sends Get ISCP Data message 1301, FIG. 13A, to primary broker 301 to request the rest of the principal's ISCP provisioning data. This includes principal i-number 523, principal i-name(s) 523N, principal passphrase salt 534S, principal public key 542, blinded principal private key 544B, and OpenID principal i-number 523O. Primary broker 301 returns this data in Get ISCP Data Response message 1301R, FIG. 13B. Since all ISCP provisioning information is sensitive from a security standpoint, selector data access module 260, FIG. 2, should store this information securely in a local datastore 271. In one preferred embodiment, selector 200 performs this function by calling selector cryptography module 240 to encrypt the information prior to storage. Even greater security can be achieved if selector cryptography module 240 is able to call the aforementioned trusted platform module, or an encrypted hard drive, or another hardware-based security module to invoke secure storage services at the hardware layer. This completes ISCP provisioning of a new selector for an existing principal account.

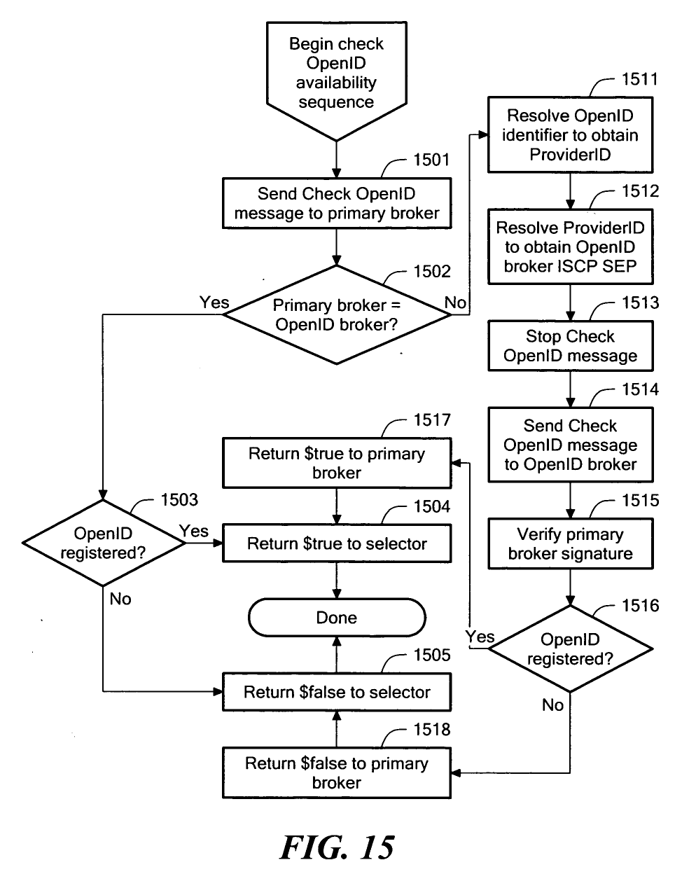

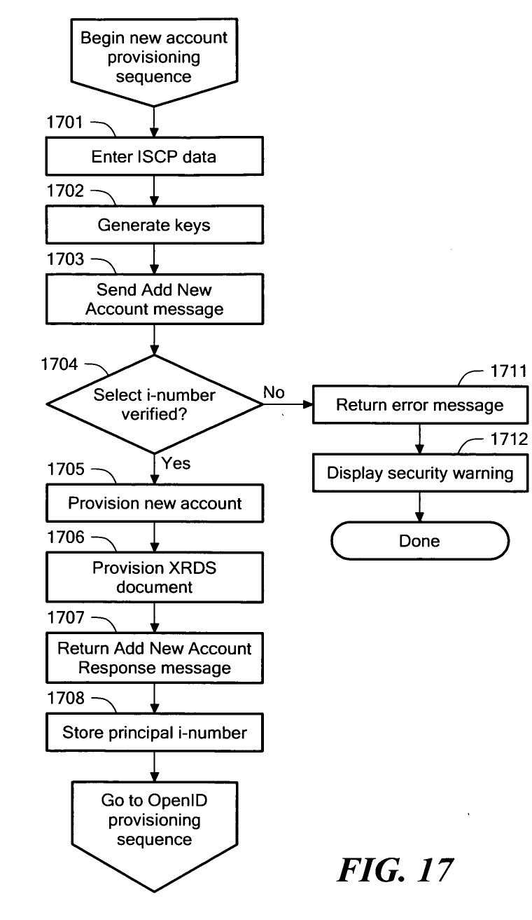

For a new account, the next phase is selection of an OpenID identifier for principal 101. FIG. 14 is a flow diagram showing the primary steps involved. In step 1401, principal 101 enters their desired OpenID identifier and the associated principal password 532. In step 1402, selector communications module 250, FIG. 2, performs XRI trusted resolution on this OpenID identifier to obtain the associated XRDS document. Note that if the OpenID identifier does not yet exist, under ISCP this should still produce an XRDS document describing the host authority. From this XRDS document selector 200 extracts the XRDS ProviderID element. Step 1403 is a test whether this element is present and its value is a valid XRI or https: URI. If this test fails, the selector must loop back to step 1401. If this test succeeds, in step 1404 selector 200 performs a second round of XRI trusted resolution on ProviderID element value to obtain the XRDS document for OpenID broker 303. Selector 200 then extracts the ISCP service endpoint using the XRDS Service/Type element value of $xdi$iscp$v$1. Step 1405 is a test whether this service endpoint type is present. If the test fails, selector 200 must loop back to step 1401. If the test succeeds, selected OpenID identifier supports ISCP and provisioning may proceed. Step 1406 is a test whether principal 101 desires registration of a new OpenID identifier or provisioning of an existing OpenID identifier. If the former, selector 200 proceeds to the check OpenID availability sequence illustrated in FIG. 15. If the latter, selector 200 proceeds to the new account registration sequence illustrated in FIG. 17.

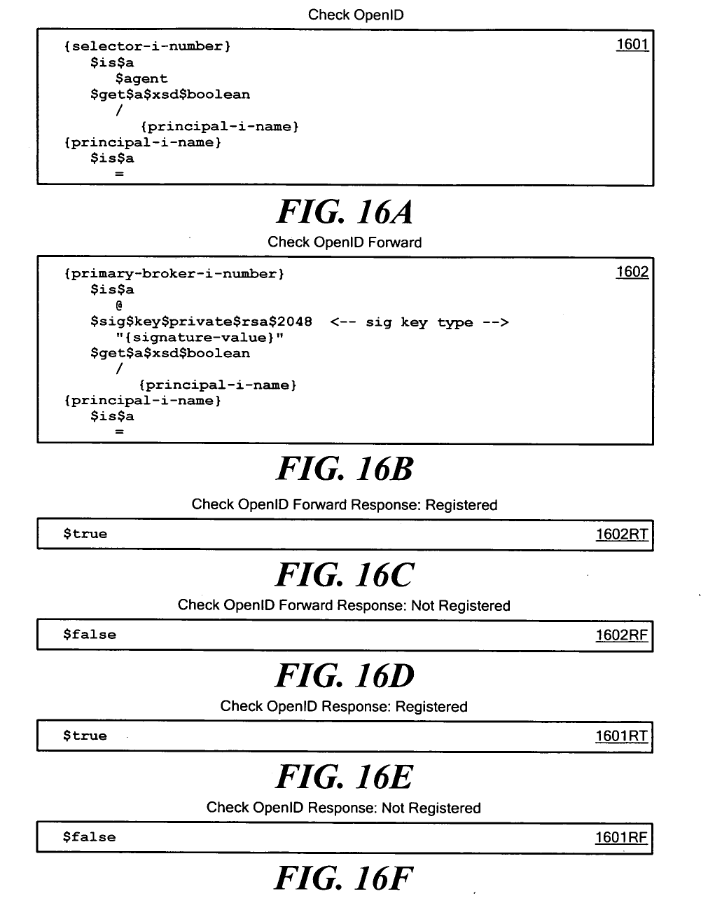

While the sequence in FIG. 14 confirms whether a particular OpenID identifier supports ISCP provisioning, it does not test whether that OpenID identifier is available for registration. FIG. 15 is a flow diagram depicting the steps for the latter. In step 1501, selector 200 communications module 250, FIG. 2, sends Check OpenID message 1601, in FIG. 16A, to primary broker 301. This message uses the XDI $get$a$xsd$boolean operator, which means primary broker 301 will return an XDI document with either $true or $false depending on whether the requested principal i-name 523N is already registered or not. In step 1502 primary broker 301 checks the requested principal i-name 523N to see if primary broker 301 is also the authoritative OpenID broker 303, i.e., if primary broker 301 hosts the authoritative OpenID registry. If so, in step 1503 primary broker 301 checks whether the requested principal i-name 523N is registered. If it is registered, in step 1504 primary broker 301 returns the Check OpenID Response message 1601RT, FIG. 16E to the selector. If it is not registered, in step 1505 it returns the Check OpenID Response message 1601RF, FIG. 16F.

If primary broker 301 is not the authoritative OpenID broker 303 in step 1502, then in step 1511 and 1512 primary broker 301 performs the same XRI trusted resolution steps as steps 1402 and 1404 of FIG. 14. In step 1513 primary broker 301 signs Check OpenID Forward message 1602 shown in FIG. 16B using its primary broker private key 543, the signature is over the {primary-broker-i-number} subject graph exclusive of the signature itself and is inserted as the value of the $sig$key$private$rsa$2048 predicate. In step 1514, primary broker 301 sends this message to OpenID broker. In step 1515, OpenID broker verifies primary broker 301 signature to guard against malicious queries. In step 1516, OpenID broker 303 checks whether the requested principal i-name 523N is registered. If it is registered, in step 1517 OpenID broker returns Check OpenID Forward Response message 1602RT, FIG. 16C to primary broker 301. In step 1504, primary broker 301 returns this message to selector 200. If it is not registered, in step 1518 OpenID broker returns Check OpenID Forward Response message 1602RF, FIG. 16D, to primary broker 301. In step 1505, primary broker 301 returns this message to selector 200. If the requested principal i-name 523N is registered, selector UI module 220, FIG. 2, informs principal 101, FIG. 1, and the sequence is repeated for the next requested principal i-name 523N. Otherwise the selector can proceed with provisioning of a new account.

FIG. 17 is a flow diagram showing the steps in the new account provisioning process. In step 1701, selector UI module 220, FIG. 2, prompts principal 101 to enter all ISCP provisioning information originating at selector 200 as explained above. This may vary depending on whether selector 200 was installed via a generic or custom download. In step 1702, FIG. 17, the selector cryptography module 240, FIG. 2, generates all the required keys as explained above. In a preferred embodiment, it uses principal passphrase 534 and principal passphrase salt 534S to generate the principal symmetric key 546; principal password 532 and principal passphrase 534 to generate primary broker password 536; and principal symmetric key 546 to encrypt blinded principal private key 544B, selector cryptography module 240, FIG. 2. It also hashes principal password 532 to create principal password hash 532H.

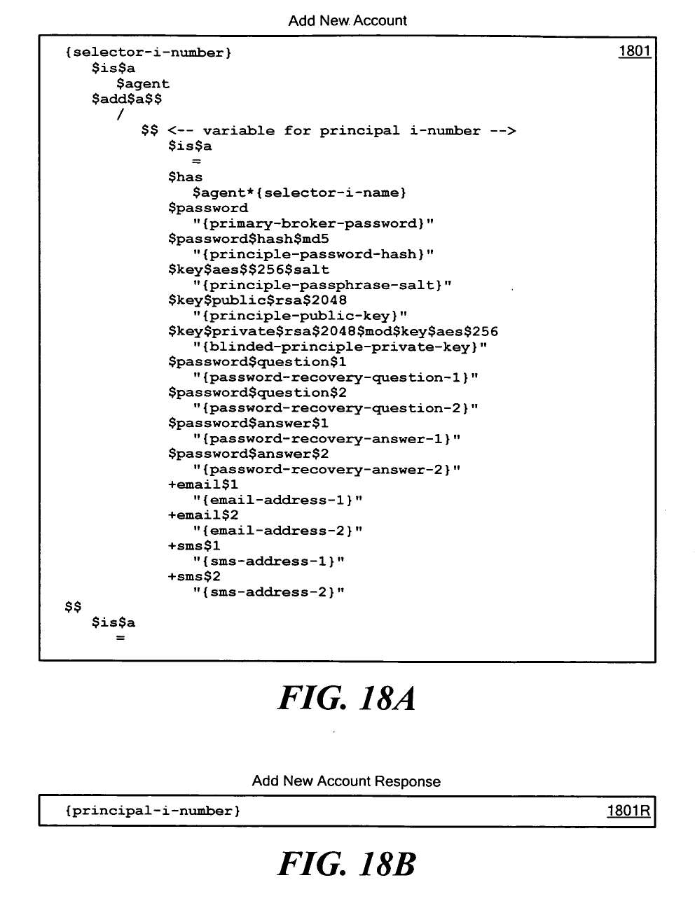

In step 1703, FIG. 17, selector communications module 250 composes and sends Add New Account message 1801, FIG. 18A to primary broker 301. This includes all ISCP data necessary to register a new account. The XDI $add$a$$ operator instructs the server to assign the XRI i-number represented by the XDI variable $$ and return it to the client. To prevent rogue account registrations, in step 1704, FIG. 17, primary broker 301 verifies that the message originates from a valid selector i-number 525. If the selector i-number does not verify, in step 1711 primary broker returns the XDI error message $false/$error/{selector-i-number}. In step 1712, selector 200 displays a security warning to principal 101 and terminates the sequence.

If selector i-number 525 is verified in step 1704, in step 1705 primary broker 301 proceeds with all internal steps necessary to register a new account. Primary broker 301 registers a new principal i-number 523 representing the account in its broker registry 381, then provisions the account with the attributes and values supplied in the subgraph of the XDI $add$a$$ predicate in the Add New Account message 1801R, FIG. 18A. It also creates a bi-directional link between principal i-number 523 and selector i-number 525 so the primary broker is able to associate the same account data and authentication credentials with multiple selectors 200 being used by same principal 101.

As with selector 200, primary broker 301 should store all ISCP provisioning information securely in datastore 371. In a preferred embodiment, primary broker 301 performs this function by calling cryptography module 340, FIG. 3, to hash values that only need to be stored for future comparison, such as hashing the primary broker password 536 and storing only the primary broker password hash 536H. Cryptography module 340 may also be used to encrypt data prior to storage. Other database or hardware-based security mechanisms may also be used to maximize protection.

In step 1706, FIG. 17, primary broker 301 provisions an XRDS discovery document for this new account. An example principal XRDS document 1901 is shown in FIG. 19. It contains the registry i-number 527 as the value of the ProviderID element, principal i-number 523 as the value of the CanonicallD element; and principal public key 542 in an X.509 certificate as the value of the KeyInfo/X509Data/X509Certificate element. The structure of the KeyInfo element is specified by the “XML Signature Syntax and Processing (Second Edition)” specification published by the World Wide Web Consortium (W3C) available at http://www.w3.org/TR/xmldsig-core/. It also contains two service endpoints: primary broker ISCP endpoint 551 and principal XDI endpoint 553. (A principal OpenID endpoint 553O is also shown in FIG. 19, however this is only required if primary broker 301 also serves as the principal's OpenID broker 303 as further described herein.) This document is used in XRI trusted resolution operations to send and receive XDI messages on behalf of the principal 101 as described throughout this specification.

In step 1707, FIG. 17, primary broker 301 returns the Add New Account Response message 1801R, FIG. 18B, to selector 200. This message includes the principal i-number 523 assigned by primary broker 301 as requested by the XDI $add$a$$ operator in Add New Account message 1801, FIG. 18A. In step 1708, FIG. 17, selector 200 securely stores the principal i-number 523 in the selector data store 271. The sequence then continues with OpenID provisioning.

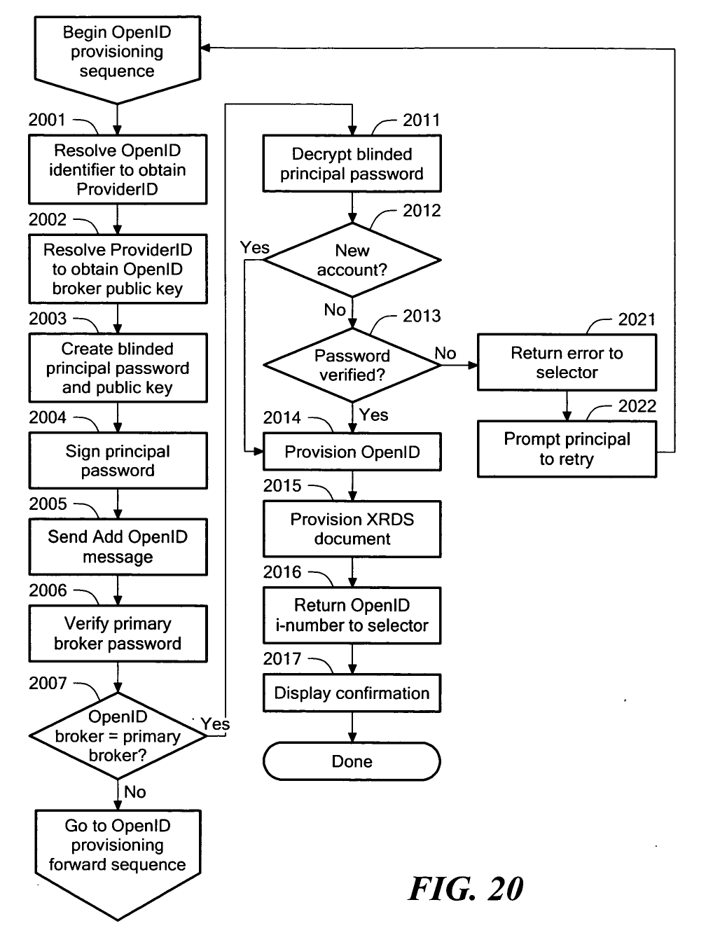

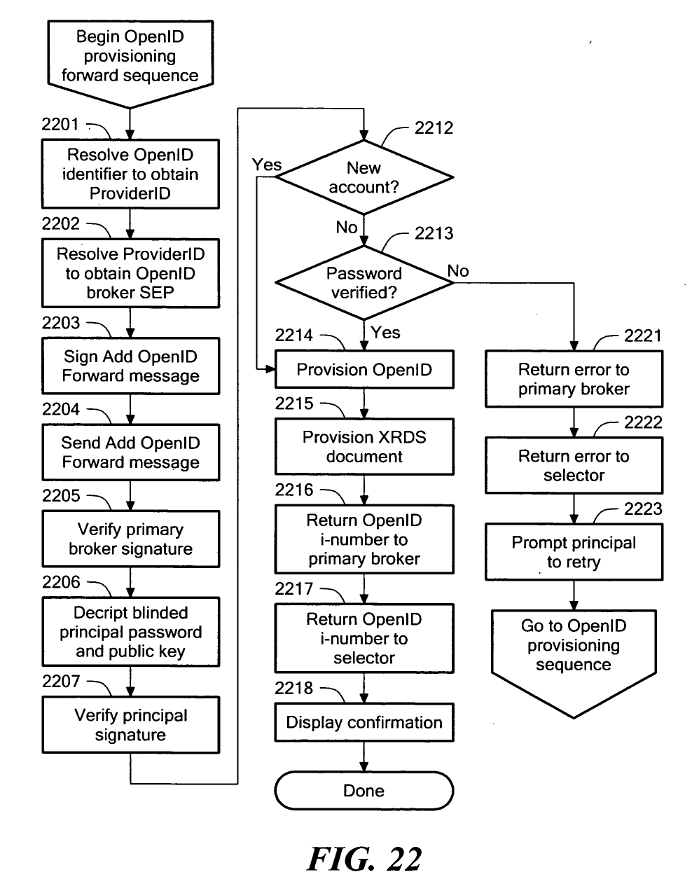

The ISCP protocol provides for both provisioning of an existing OpenID identifier (if the OpenID broker supports ISCP) as well as registration of a new OpenID identifier. It can also perform these operations transparently for principal 101, FIG. 1, whether primary broker 301 serves as the principal's OpenID broker 303 or whether a separate service provider performs that function. FIG. 20 is a flow diagram showing the steps of an OpenID provisioning process. In step 2001, selector 200 performs XRI trusted resolution on the chosen principal i-name 523N to obtain the associated XRDS document. The selector then selects the principal OpenID endpoint 553O and extracts the ProviderID element value. In step 2002, selector 200 performs a second round of XRI trusted resolution on the ProviderID element value to obtain the XRDS document for OpenID broker 303 and extracts the X509 Certificate element to obtain OpenID broker public key 541O. In step 2003, selector cryptography module 240 creates a blinded version of principal password 532 and principal public key 542 by encrypting each with OpenID broker public key 541O. In step 2004, FIG. 20, selector cryptography module 240 creates a signature of principal password 532 using principal private key 544. In step 2005, selector communications module 250 creates and sends Add OpenID message 2201, FIG. 22, to primary broker 301. This message uses the XDI $add$a$$ operator to request registration of a principal OpenID i-number 523O.

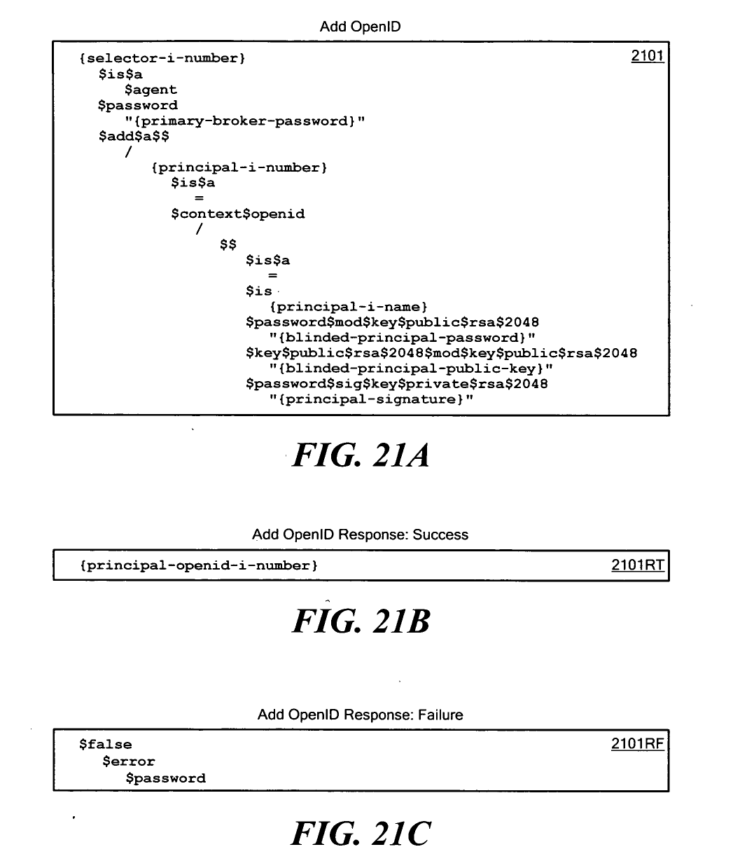

In step 2006, FIG. 20, primary broker 301 authenticates the message by verifying primary broker password 536 (this password was just provisioned so in normal operations it should not fail). Step 2007 is a test whether primary broker 301 is also OpenID broker 303. If they are not the same, primary broker 301 continues with OpenID forward provisioning sequence described in FIG. 22. If they are the same, in step 2011, FIG. 20, primary broker 301 uses its primary broker 301 private key 543 to decrypt the blinded version of principal password 532. Step 2012 is a test whether the request $add$a$$ operation represents ISCP provisioning of an existing OpenID account or registration of a new OpenID account. To do this, primary broker 301 checks whether principal i-name 523N (the object of the $is predicate of the $add$a$$ subgraph in Add OpenID message 2201, FIG. 21A) is already registered. If it is registered, then in step 2013, FIG. 20, primary broker 301 verifies principal password 532 with the existing account. If it does not verify, in step 2021, primary broker 301 returns Add OpenID Response: Failure message 2101RF, FIG. 21C to selector 200. In step 2022, selector UI module 220, FIG. 2, prompts principal 101, FIG. 1, to retry either a different OpenID identifier or a different principal password 532, and the sequence is restarted.

If principal 101 is registering a new account in step 2012, FIG. 20, or if the password verifies in step 2013, then in step 2014, primary broker 301 proceeds with provisioning of OpenID account, including registration of a principal OpenID i-number 523O if one has not already been assigned. (The principal i-number 523 and principal OpenID i-number 523O may be the same depending on the primary broker's policies governing operation of its OpenID registry.) In step 2015, primary broker 301 provisions an XRDS document associated with both principal i-name 523N and principal OpenID i-number 523O. This XRDS document includes a principal OpenID endpoint 553O from which principal 101 may now obtain OpenID service using principal password 532 even if principal 101 is not using selector 200. This has the advantage of allowing principal to remember and use only one principal password 532 whether they are using a provisioned selector or using a standard Internet browser. It also makes it more feasible for the principal to create and maintain a strong password.

In step 2016, primary broker 301 returns Add OpenID Response: Success message 2101RT, FIG. 21B, to selector 200. In step 2017, selector UI module 220 displays to confirmation that the principal's account and OpenID registration is complete. In a preferred embodiment, this display includes additional account protection instructions to principal such as: a) recording principal i-name 523N, principal password 532, and principal passphrase 534 and safely storing this recording in a protected location such as a safety deposit box, b) only entering their principal password 532 into a trusted selector or verified OpenID account login page served by their OpenID broker 303, and c) only entering their principal passphrase 534 into a trusted selector. These screens should also include instructions for how to safely recover a lost password or add a new selector as further described herein.

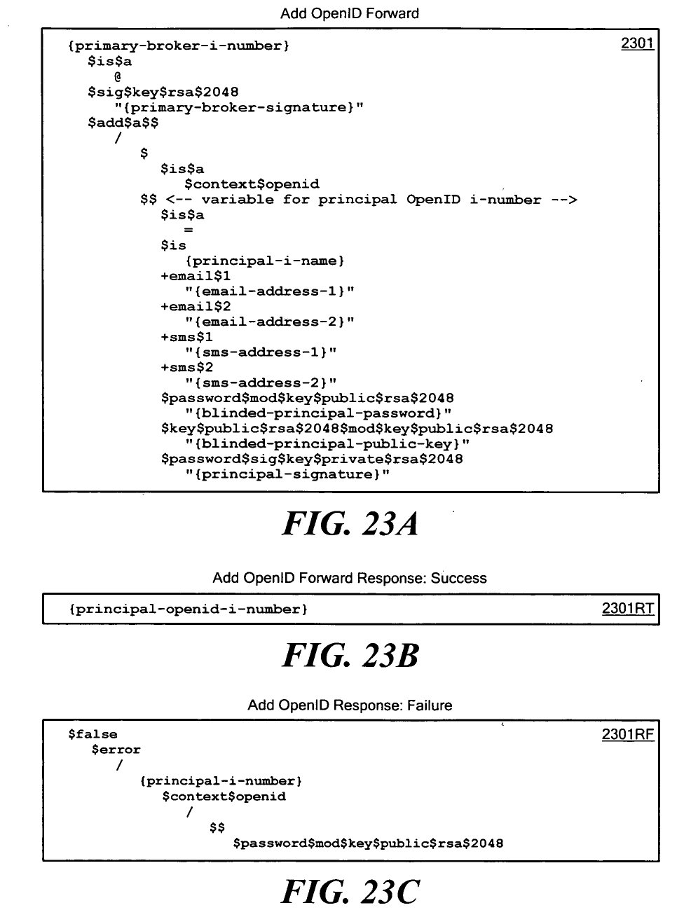

If primary broker 301 is not OpenID broker 303 in step 2006, primary broker 301 continues with OpenID forward provisioning sequence described in FIG. 22. In step 2201, primary broker 301 performs the same XRI trusted resolution step as selector 200 performed in step 2001, FIG. 20. In step 2202, primary broker 301 performs XRI trusted resolution on the value of ProviderID element to obtain the XRDS document for OpenID broker 303 and extracts OpenID broker ISCP endpoint 551O to obtain the value of its highest priority URI element (which must be an https: URI). In step 2203, primary broker 301 uses its primary broker private key 543 to sign Add OpenID Forward message 2301, FIG. 23. The signature appears as the object of the $sig$key$private$rsa$2048 predicate and covers the entire {primary-broker-i-number} graph exclusive of the signature itself. The example message shown assumes that service endpoints to be provisioned by OpenID broker 303 will be determined by that broker's policy. However provisioning of specific service endpoints desired by principal 101 or primary broker 301 may be requested by including $context predicates in the message corresponding to each request service endpoint. If necessary these predicates may include a subgraph of the $context predicate containing provisioning attributes and values specific to the desired service endpoint. In step 2204, primary broker 301 sends Add OpenID Forward message 2301 to the https: URI of the OpenID broker ISCP endpoint 551O.

In step 2205, OpenID broker 303 first verifies primary broker 301 signature. If it does not have a copy of primary broker public key 541 cached, it looks it up by performing XRI trusted resolution on primary broker i-number 521 and extracting the X509 Certificate element. Assuming this signature verifies, in step 2206, OpenID broker 303 next decrypts blinded principal password 532 and blinded principal public key 542 using OpenID broker private key 543O. In step 2207, OpenID broker 303 uses the principal public key 542 to verify the principal's signature on principal password 532 (this signature is the value of the $password$sig$key$private$rsa$2048 predicate). Assuming this verifies, steps 2212 and 2213 then follow the same tests as steps 2012 through 2013, FIG. 20A.

If principal password 532 does not verify in step 2213, in step 2221 primary broker 301 returns Add OpenID Forward Response: Failure message 2201RF, FIG. 23C, to primary broker 301. In step 2222, FIG. 22, primary broker 301 passes this same message through to selector 200. In step 2223, selector UI module 220, FIG. 2, prompts principal 101 to retry either a different OpenID identifier or a different principal password 532, and the sequence is restarted.

If the principal password 532 is verified in step 2213, FIG. 22, steps 2214 and 2215 follow the same OpenID provisioning process as steps 2012 and 2013, FIG. 20. In step 2216, FIG. 22, OpenID broker 303 returns Add OpenID Response: Success message 2301RT, FIG. 23B to primary broker 301. In step 2217, primary broker 301 passes this same message through to selector 200. In step 2218, selector UI module 220, FIG. 2, displays the same account registration success information to the principal as in step 2017, FIG. 20.

This completes ISCP provisioning of a selector for a new primary broker and OpenID broker account. The preceding sequences have also covered provisioning of a new selector for existing accounts. This enables principal 101 to install more than one selector 200 on more than one device, as well as to recover the use of their accounts if a device is broken or lost or the selector stops working. Installation of multiple selectors also provides redundancy of the principal's ISCP data stored locally by a selector. However for maximum security the selector should not store a copy of the principal's primary authentication credentials, such as the principal password 532. This means that if such credential stolen or lost, the principal must have a mechanism for modifying it or recovering it—loss of authentication credentials should no more result in loss of a principal's broker accounts than loss of a driver's license should cause a person to lose their bank accounts. Therefore ISCP includes support for both functions.

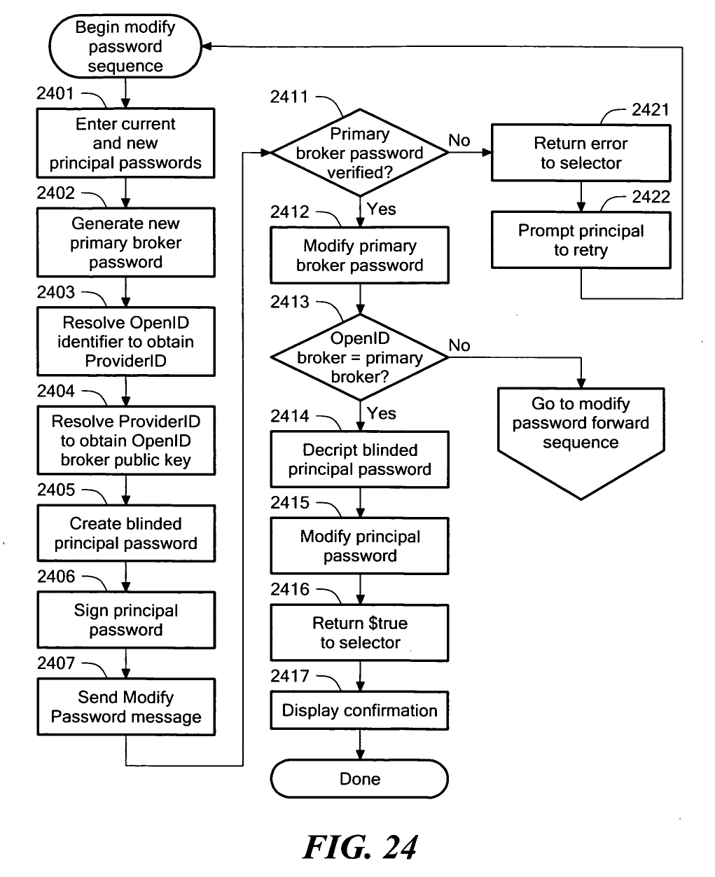

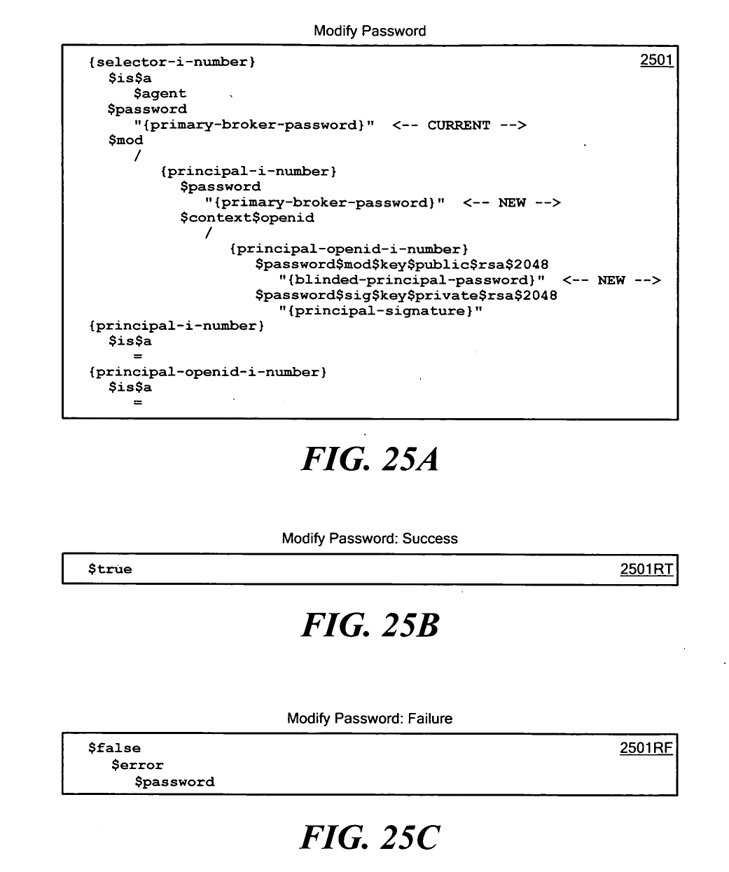

FIG. 24 is a flow diagram showing the typical steps involved in the process for principal 101 to modify their principal password 532. In step 2401, selector UI module 220 prompts principal 101 to enter both their current and their new principal password 532. In step 2402, selector cryptography module 240 generates a new primary broker password 536 as previously described. Steps 2403 through 2406 are identical to steps 2001 through 2004, FIG. 20 with the exception that it is not necessary to create a blinded principal public key 542. In step 2407, selector communications module 250 creates and sends the Modify Password message 2501, FIG. 25, to primary broker 301. This message uses the XDI $mod operator to request modification of principal password 532 and primary broker password 536.

Although incorrect entry of a principal password 532 can be detected locally by selector 200 by comparing it at the time of entry with principal password hash 532H, for security purposes primary broker 301 must also verify primary broker password 536. This test is performed in Step 2411. If it does not verify, in Step 2421, primary broker returns the Modify Password Response: Failure message 2501RF, FIG. 25C to selector 200. In step 2422, FIG. 24, selector UI module 220 prompts principal 101 to retry principal password 532, and the sequence is restarted.

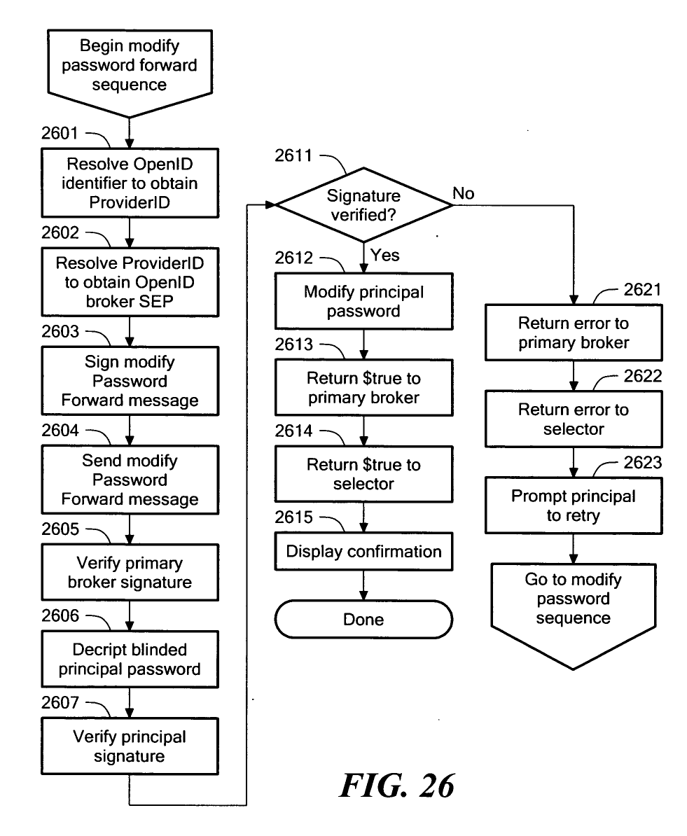

If the current primary broker password 536 verifies in step 2411, then in step 2412 primary broker 301 modifies primary broker password 536 to the new value. Step 2413 is a test whether primary broker 301 is also the OpenID broker 303. If they are not the same, primary broker continues with the modify password forward sequence described in FIG. 26. If they are the same, in step 2414, FIG. 24, primary broker 301 uses its primary broker private key 543 to decrypt the blinded version of principal password 532. (Note that it does not need to verify the principal's signature because it has already verified the message using the primary broker password 536.) In step 2415, primary broker 301 modifies the value of principal password 532. In step 2416, primary broker 301 returns the Modify Password Response: Success message 2501RT, FIG. 25B to selector 200. In step 2417, selector UI module 220 displays confirmation that the principal's password modification is complete.

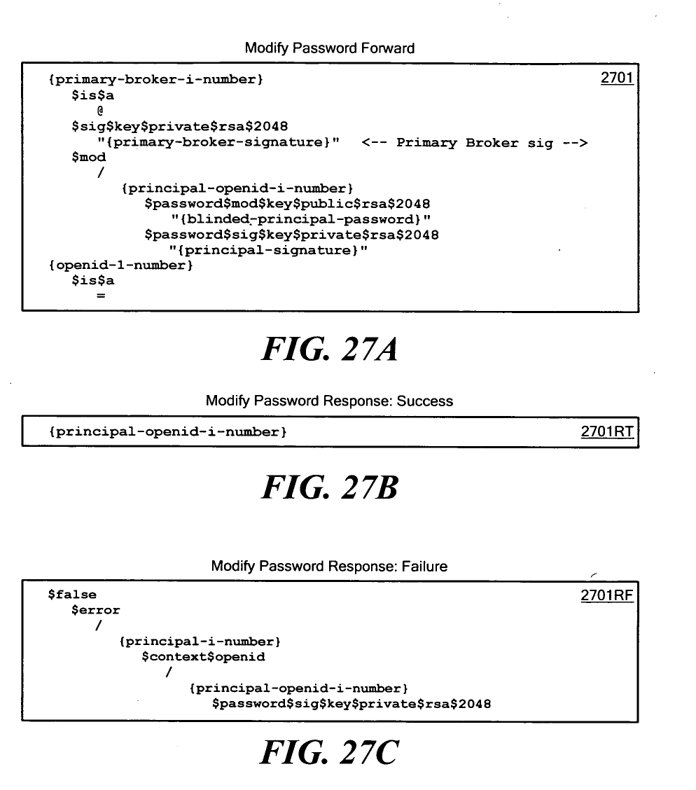

If in step 2413, primary broker 301 is not the OpenID broker 303, primary broker 301 continues with the modify password forward sequence described in FIG. 26. Steps 2601 through 2607 are identical to steps 2201 through 2207 of FIG. 22 with the exception that they apply to the Modify Password Forward message 2701 shown in FIG. 27A, and that it is not necessary to create a blinded principal public key 542.

Step 2611, FIG. 26, is a test where OpenID broker 303 verifies principal signature on principal password 532. If it does not verify, in Step 2621 primary broker 301 returns the Modify Password Forward Response: Failure message 2701RF, FIG. 27C, to selector 200. In step 2622, primary broker 301 passes this same message through to selector 200. In step 2623, selector UI module 220 prompts principal 101 to retry the current principal password 532, and the sequence is restarted.

If in step 2611, principal signature on principal password 532 does verify, in step 2612 OpenID broker modifies the value of principal password 532. In step 2613, OpenID broker 303 returns the Modify Password Forward Response: Success message 2701RT, FIG. 27B to primary broker 301. In step 2614, primary broker 301 passes this same message through to selector 200. In step 2615, selector UT module 220 displays the same password modification confirmation to principal 101 as in step 2417 of FIG. 24.

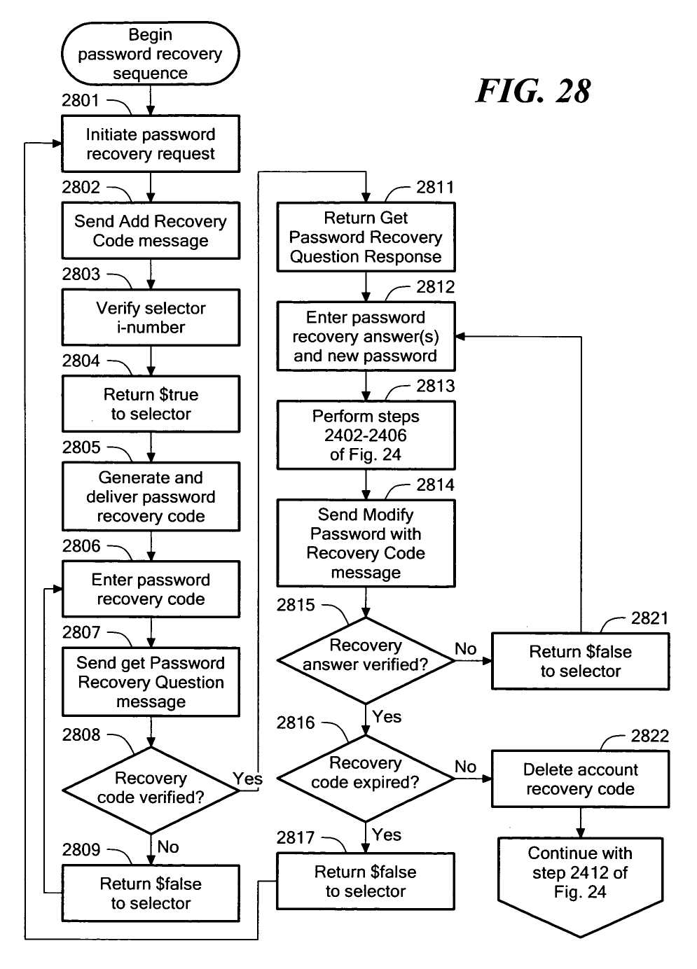

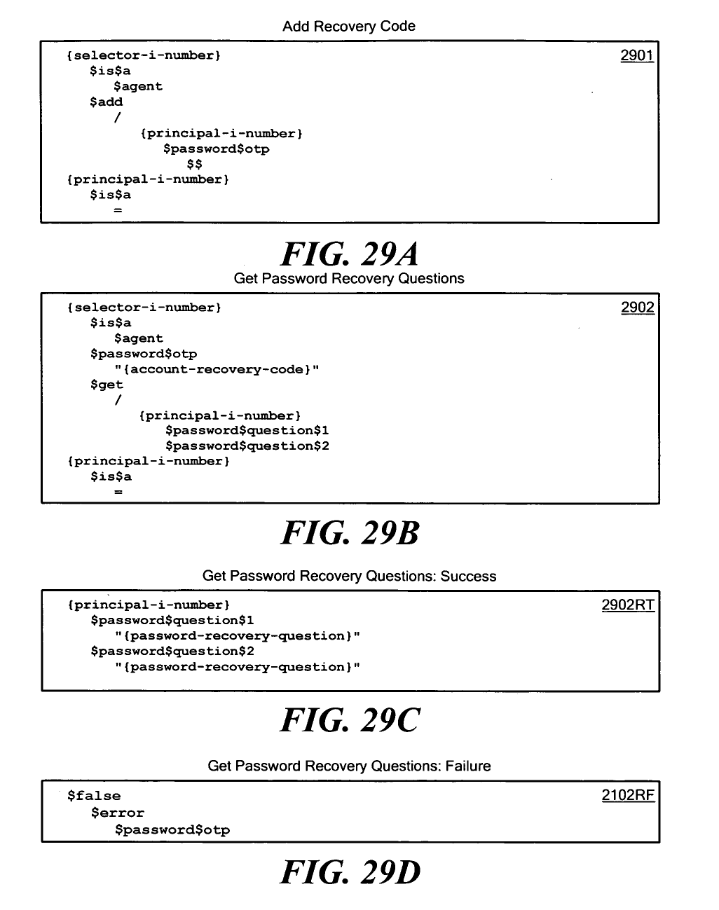

If principal 101 loses or forgets principal password 532, ISCP also supports password recovery. FIG. 28 is a flow diagram showing the steps in the password recovery sequence. In step 2801, principal 101 initiates a password recovery request via selector UI module 220. In step 2802, selector communications module 250 sends Add Recovery Code message 2901 shown in FIG. 29A to primary broker 301. In step 2803, primary broker 301 verifies that the message originates from a valid selector i-number 525. Assuming that it verifies, in step 2804, primary broker 301 returns $true to the selector 200. In step 2805, primary broker 301 generates an account recovery code 531, stores it together with an expiration date stamp in the principal's account associated with selector i-number 525, and delivers it via one or more of the communications channels registered as account recovery data 538 for that account. In a preferred embodiment the account recovery code 531 is delivered via all registered communications channels and includes a security warning to principal 101 with instructions and a link to contact the primary broker in case the recovery code request was generated fraudulently.

In step 2806, principal 101 enters the account recovery code 531 via selector UT module 220. In step 2807, selector communications module 250 sends Get Password Recovery Questions message 2902, FIG. 29B, to primary broker 301. This message includes account recovery code 531 as the object of the $password$otp predicate. Step 2808 is a test if the account recovery code 531 verifies against the value stored in the account associated with selector i-number 525. If it does not verify, in step 2809, primary broker returns Get Password Recovery Questions: Failure message 2902RF, FIG. 29D to selector 200. Selector 200 returns to step 2806 to prompt principal 101 to reenter the account recovery code 531.

If the account recovery code 531 is verified in step 2808, in step 2811, primary broker returns Get Password Recovery Questions: Success message 2902RT, FIG. 29C to selector 200. In step 2812 selector UI module 220 displays at least one of the password recovery questions 540Q from this response and prompts principal 101 to enter the corresponding password recovery answer 540A. In step 2813, selector 200 performs the same functions as in steps 2402 through 2406 of FIG. 24. In step 2814, selector communications module 250 sends Modify Password with Recovery Code message to primary broker 301. This message is identical to Modify Password message 2501 in FIG. 25 except in place of the $password predicate on the {selector i-number} subject, it has: a) a $password$otp predicate whose object is the value of the account recovery code 531, and b) a $password$answer$ {x} predicate whose object is the value of the corresponding {x} numbered password recovery answer 540A.

In step 2815, primary broker 301 tests if the account recovery code 531 and password recovery question 540Q both verify against the values stored in the associated account. If either value does not verify, in step 2821 primary broker 301 returns an error message to selector 200 indicating which value(s) did not verify, and selector 200 returns to step 2813 to prompt principal 101 to retry entry of the appropriate value(s). If both values verify, in step 2816, primary broker 301 tests if the account recovery code has expired. If it has expired, in step 2817, primary broker 301 returns an error to selector 200, and selector 200 returns to step 2801 to prompt principal 101 to initiate another password recovery request. If the account recovery code has not expired, in step 2822, primary broker 301 deletes the account recovery code 531 to ensure it is only used once. Then, primary broker 301 completes the password modification sequence starting with step 2412, FIG. 24.

All the foregoing operations of the ISCP protocol are designed to empower principal 101 to use selector 200 to easily create and control information sharing relationships across brokered information sharing system 100. A primary use case is using primary broker 301 for online storage of cards representing sets of claims the principal wishes to share with relying parties. This function of a primary broker is referred to as a card wallet. In a preferred embodiment, the communications between a selector and primary broker for card wallet services employs the XDI protocol over an HTTPS connection in the same manner as ISCP provisioning. However, a card wallet service may use any protocol for selector/broker, broker/IP and broker/RP communications that is capable of securely transferring the necessary data structures. The specific communications protocol employed is not a limiting feature of the invention.

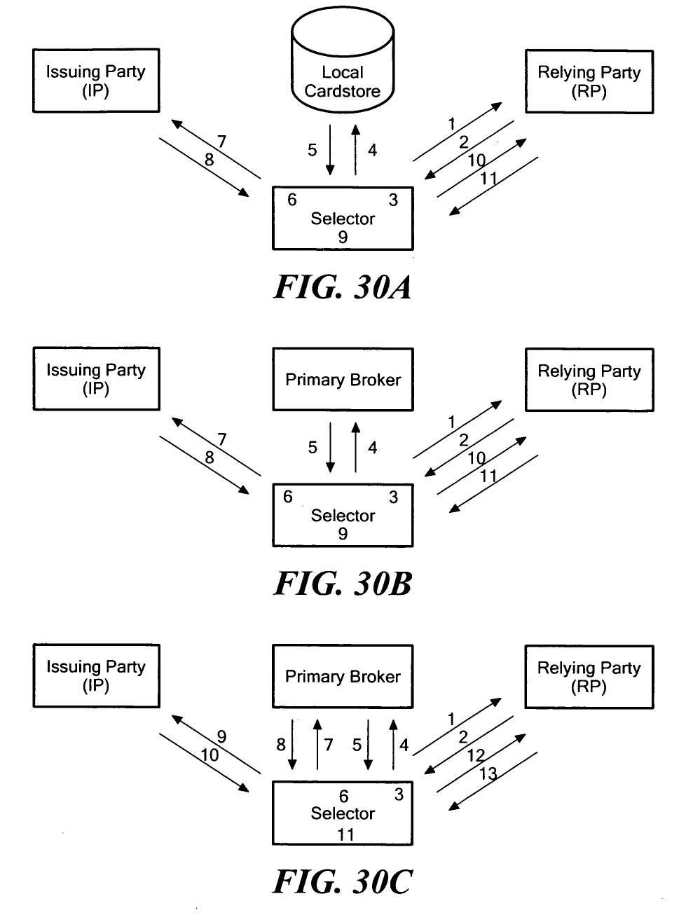

FIG. 30A is a conceptual diagram of the relationship of an issuing party (IP), relying party, and selector in the conventional card transaction model described in the aforementioned “Personal Identification Information Schemas” patent application or “Understanding Windows CardSpace” book. In this model the selector stores and retrieves cards from a local cardstore. (The steps in this diagram will be further described below.) FIG. 30B is a conceptual diagram of the same relationships with the addition of the primary broker. Conceptually, the primary broker is serving as a replacement for the local cardstore. This has two primary advantages: 1) the cardstore can be maintained and backed up to commercial standards so the cards and card data are safe if a local device is lost or stops functioning, and 2) it supports “roaming”, i.e., the ability of principal 101 to access their cardstore from multiple selectors operating across different devices and networks. Additional advantages will be further described herein.

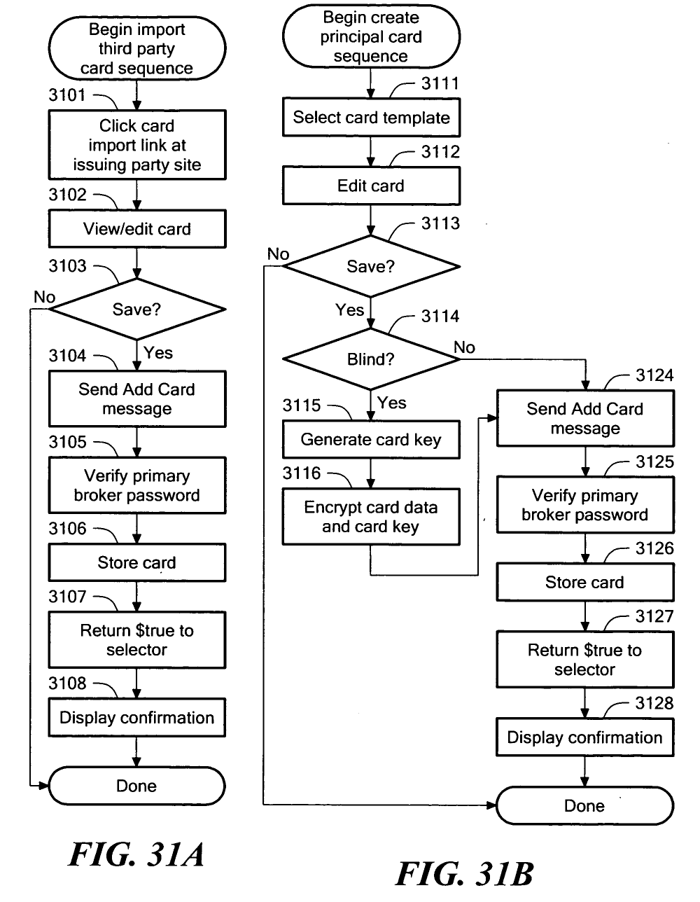

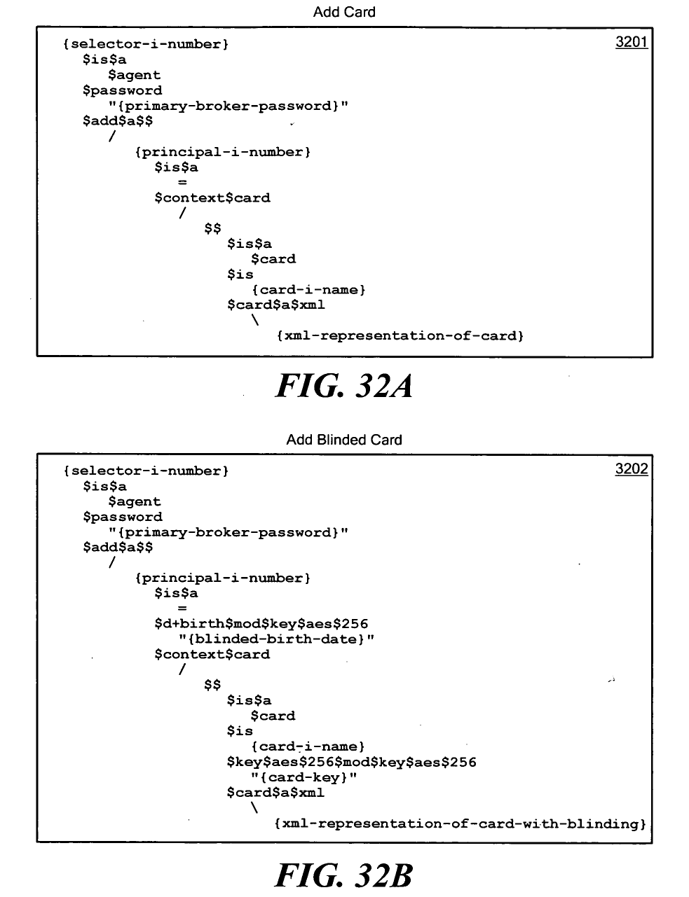

FIG. 31A is a flow diagram of the steps in the process of importing and storing a third-party card in a principal's card wallet. In step 3101, principal 101 clicks on a link to import a third-party card. Such a link may appear at the issuing party website, another website, in an email, or wherever a Web link may appear. The link may take the form of text, a button, a graphic, or however a Web link may appear. In a preferred embodiment, the link is structured so that if principal 101 does not yet have a selector 200 or account at a primary broker 301, the link will resolve to a Web page or service that enables principal 101 to download an ISCP-enabled selector, provision the necessary accounts, and automatically import the target card once the ISCP provisioning process is complete. In step 3102, selector 200 imports and displays the target i-card for viewing and editing by principal 101. For a third-party card, the principal may only have the option to edit a card i-name 529N. Other card metadata editing options may be supported by particular selectors and card wallet services. Step 3103 is a test if principal 101 wishes to discard or save the card. If the choice is to discard the card, the sequence ends. If the choice is to save the card, in step 3104 selector communications module 250 sends Add Card message 3201, FIG. 32A, to primary broker 311. In this message the $context$card predicate specifies the principal's card wallet, and the $card$a$xml predicate specifies that its object contains the XML serialization of the card as defined in the IMI specifications.

In step 3105, primary broker 301 verifies primary broker password. Assuming it verifies, in step 3106, primary broker 301 securely stores the card in the broker datastore 371, FIG. 3. In step 3107, FIG. 31A, primary broker 301 returns the XDI message to selector 200. In step 3108, selector 200 displays a confirmation to principal 101 and the sequence is completed.

FIG. 31B is a flow diagram of the steps in the process of creating and storing a principal card in a principal's card wallet. The sequence is very similar to that for a third-party card, with the key differences being that principal 101 initiates creation of the card, and the card data may optionally be blinded. Card blinding typically does not pertain to a third-party card where the data resides in repositories under the issuing party's control.

In step 3111, principal 101 initiates creation of a principal card via selector UI module 220. In a preferred embodiment, this is via reference to a card template for the type of card desired (e.g., business card, friend card, contact card, registration card, shopping card, clothing card, travel card, etc.), however, any card in the principal's card wallet may be used as a template, or the card may be created from scratch. In step 3112, principal 101 edits the card. This may include assigning a card i-name 529N, selecting an image for the card, entering or editing card metadata, adding or deleting claims, and entering or editing claim values.

Step 3113 is a test if principal 101 wishes to discard or save the card. If the choice is to discard the card, the sequence ends. If the choice is to save the card, step 3114 is a test to see if principal 101 desires blinding of the card data. Blinding may be applied automatically or on a per-card basis depending on principal and/or broker policy. If blinding is not desired, selector 200 continues with step 3124. If blinding is desired, in step 3115, selector cryptography module 240, FIG. 2, generates a card key 548. In a preferred embodiment this is an asymmetric key pair from a specific third party, the public key portion of which is used to encrypt the card data so that it can be shared with this third party while being blinded from the broker service provider as further described herein. In step 3116, FIG. 31B, selector cryptography module 240 encrypts the principal card data (but not the card itself) using the card key. It also encrypts the card key with the principal symmetric key 546.

Steps 3124 through 3128 are identical to steps 3104 through 3108 of FIG. 31A with the exception that they apply to the Add Blinded Card message 3202 in FIG. 32B. In this message the card key 548 is stored as the object of the $key$aes$256$mod$key$aes$256 predicate. If the principal card data is stored as the card claim values in the XML serialization of the card, these values have been encrypted with the card key 548.

Alternately, in addition to the data sharing just described using the card key 548, selector 200 or primary broker 301 may store some or all of these claims values independently of the XML serialization of the card. In a preferred embodiment, this is done to enable keeping claim values consistent across multiple cards, as well as sharing these claims via other data sharing protocols. In this case the claims may be stored in the principal's own XDI context, in another XDI context, in a Higgins IdAS context, or in any other context available for this purpose. For blinding these claim values are encrypted with the principal symmetric key 546. An example shown in FIG. 32B is the principal's date of birth. This is stored in the principal's own XDI context (the subject) as the object of the predicate. Any card referencing this claim can store the XRI address of this claim ({principal i-number}/$d+birth$mod$key$aes$256) in order to retrieve the value of this claim when producing a copy of the card.

FIG. 30A is a diagram of the steps involved with card selection and submission in the conventional card transaction model defined in the IMI specifications. In step 1 the principal requests a card-protected resource from the RP. In step 2, the RP returns the security policy that pertains to the resource. In step 3 the principal invokes the selector to choose a card (typically by clicking a standard card icon). In step 4 the selector uses the security policy to request the set of cards matching this security policy from the local cardstore. In step 5 the cardstore returns the set of matching cards. In step 6 the principal selects a card and enters the necessary authentication credentials. In step 7 the selector submits the authentication credentials and requests the corresponding security token from the IP. In step 8 the IP returns the security token. In step 9 (optional) the principal reviews the claim values in the security token and authorizes submission to the RP. In step 10 the selector forwards the security token to the RP. In step 11 the RP returns the original resource requested.

In FIG. 30B the only difference is that the local cardstore has been replaced by or the local cardstore is synchronized to the primary broker as a network-accessible cardstore. Thus, in FIG. 30B, steps 4 and 5 become network protocol calls between the selector 200 and primary broker 301.

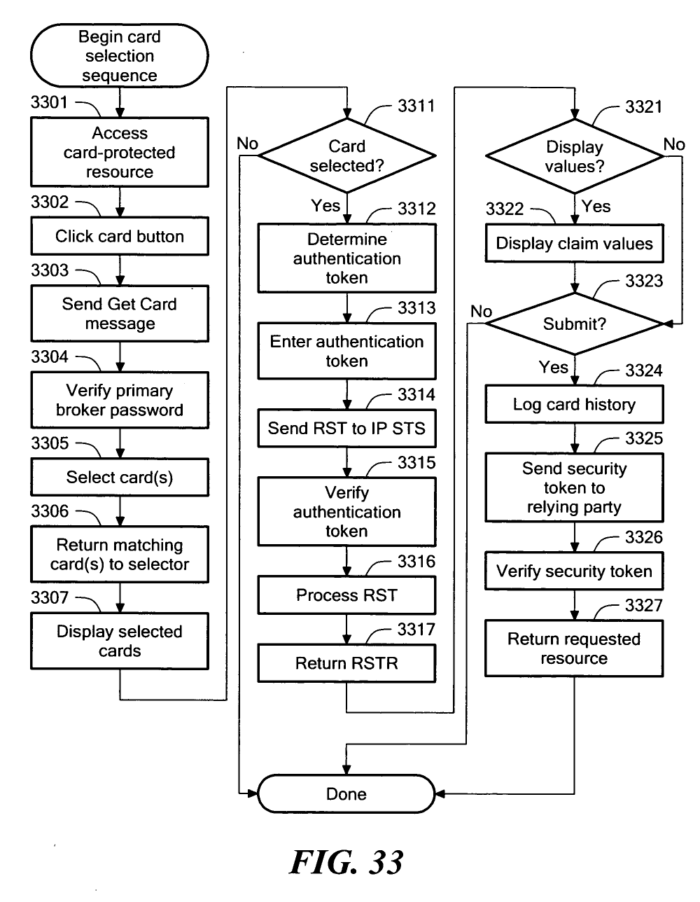

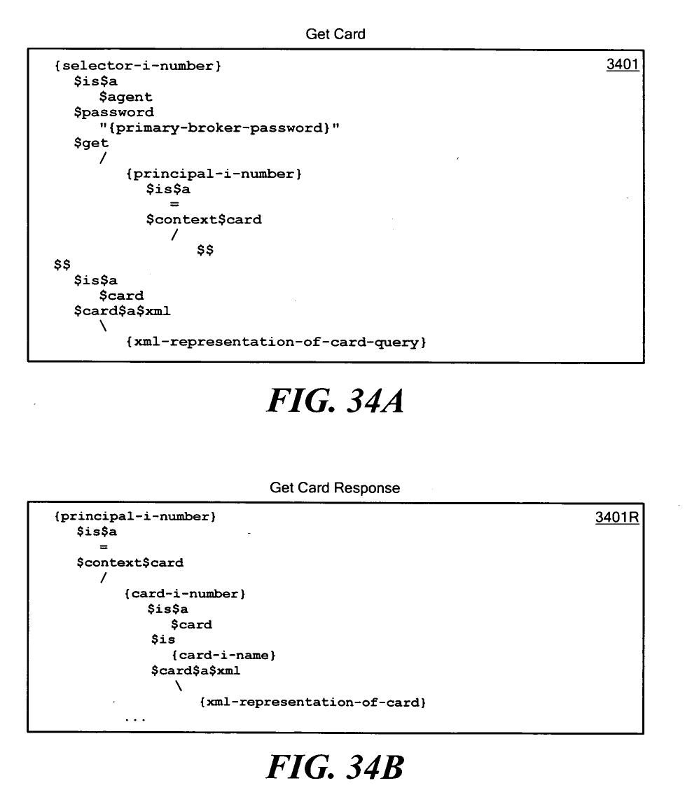

FIG. 33 is a more detailed flow diagram of the conceptual steps in FIG. 30B. In step 3301, principal 101 requests a card-protected resource. This downloads a web page containing markup code describing the RP security policy or providing a link to this policy as described in the IMI specifications. In step 3302, principal 101 clicks the link initiating card-based authentication, activating the selector 200. In step 3303, selector 200 reads the security policy and the selector communications module 250 composes and sends the Get Card message 3401 shown in FIG. 34A to primary broker 301. This message is referred to as an XDI query since the subgraph of the XDI $get operator includes an XDI $$ variable. This variable is defined in the outer graph as being a card ($$/$is$a/$card) and the detailed query corresponding to the requirements of the RP security policy is serialized in XML as the object of the $card$a$xml predicate.

In step 3304, primary broker 301 verifies primary broker password 536. Assuming it verifies, in step 3305, primary broker 301 data access module 360 uses a data adapter 361 to query the datastore(s) 371 serving as the cardstore(s) for the card wallet to obtain the set of cards matching the selector query. In step 3306, FIG. 33, primary broker 301 returns the Get Card Response message 3401R, FIG. 34B containing the set of matching cards to the selector. The example message shows one matching card, however the match could be zero or more. In step 3307, selector UI module 220, FIG. 2, displays the set of matching cards to principal 101.

Step 3308 is a test of whether a card is selected. If not, the sequence is complete. If a card is selected, in step 3312 selector 200 consults the card metadata to determine the card type. Assuming it is a third-party card, the selector also determines the required authentication scheme as defined in the IMI specifications. IMI 1.0 supports four authentication schemes: X.509 certificate, Kerberos token, username/password, and principal card, however it may be extended to additional authentication schemes. In step 3313, selector UI module 220 prompts principal 101 to submit the necessary authentication credential. In step 3314, selector 200 sends the WS-Trust Request for Security Token (RST) message including the authentication credential to the IP. In step 3315, IP cryptography module 440, referred to as a security token service (STS), verifies the authentication credential. In step 3316, IP STS processes the RST request, gathers the necessary claims data, and performs any necessary claims transformations. In step 3317, IP STS returns the WS-Trust Request for Security Token Response (RSTR) message containing the security token to the selector.

Step 3321 is a test of whether principal 101 requested to see the claims values. If not, selector 200 skips to step 3323. If principal 101 requested to see the claims values, in step 3322, selector UI module 220 displays the claims values. Step 3323 is an optional test, depending on the principal's preferences, of whether the principal wishes to proceed with submitting the security token to the RP. If not, the sequence is complete. If the principal chooses to submit the card, in step 3324 selector 200 logs this action in the card transaction history, which it can subsequently synchronize with the card wallet at primary broker 301. In step 3325, selector 200 forwards the security token to the RP. In step 3326, the RP verifies the IP's signature on the security token, and also verifies that the submitted claims satisfy the RP's security policy. If so, in step 3327, the RP returns the originally requested resource.

If the card selected in step 3308 is a principal card, selector 200 first determines if the card was blinded. If so, it uses the principal symmetric key 546 to decrypt the card key 548 and then uses the card key to decrypt the card data. In addition, steps 3314 through 3317 are replaced by a call from selector 200 to the selector cryptography module 240 to produce the self-signed security token that will be submitted directly to the RP in step 3325.

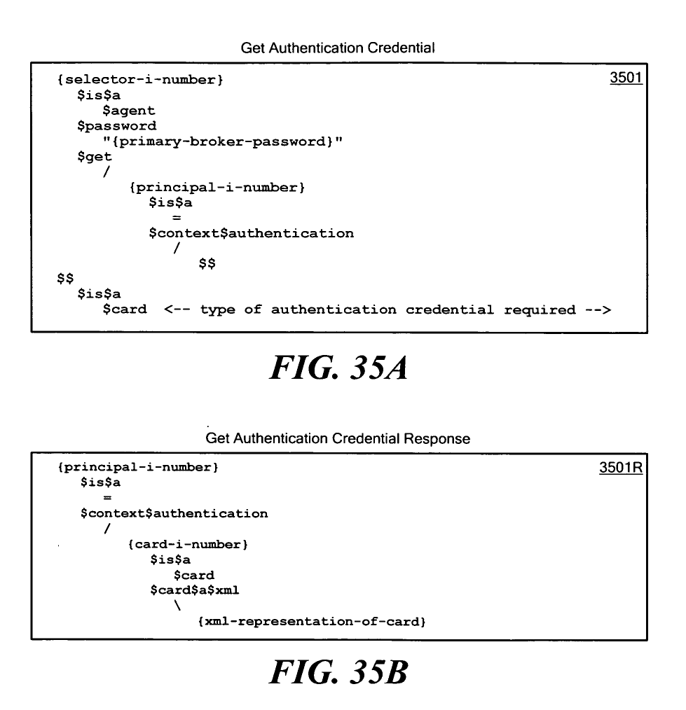

Automatic card backup and card roaming are not the only advantages of using brokered information sharing system 100 as a card wallet service. A third key advantage is the capability of primary broker 301 to provide authentication credentials to an IP 401 on behalf of principal 101. Conceptually this is very similar to the brokering of authentication credentials that selector 200 performs between an IP 401 and an RP 402 as shown in FIG. 30B. One key difference is that selector 200 requests and primary broker 301 returns the authentication credential the selector needs to forward to the IP in the RST message. This is illustrated conceptually by steps 7 and 8 in FIG. 30C (the only steps that differ from FIG. 30B). These steps take the place of step 3313 in FIG. 33. Instead of selector UT module 220 module prompting principal 101 to enter the authentication credential required by the selected card, selector communications module 250 sends Get Authentication Credential message 3501 shown in FIG. 35A to primary broker 301. This example message illustrates a request for a principal card as the authentication credential required by the IP. Primary broker 301 at a minimum verifies the primary broker password 536. However, depending on the authenticated credential requested and the primary broker's security policy, primary broker 301 may also verify other authentication credentials provided by principal 101 as further described herein. Then the primary broker 301 retrieves the requested principal card and returns Get Authentication Credential Response message 3501R, FIG. 35B to selector 200. Selector 200 is now able to call selector cryptography module 240 using the principal card to produce its own security token to include in the RST message and proceed directly with step 3314, FIG. 33.

In a preferred embodiment this process can be further optimized by in some cases combining the Get Card request with the Get Authentication Credential request so that both the matching cards and the necessary authentication credential(s) are returned in the same response.

This process is referred to as brokered authentication, and it has several advantages over the conventional card transaction model shown in FIGS. 30A and 30B. The first one is that it eliminates the need for principal 101 to be presented with an additional authentication challenge after principal 101 has already authenticated to their selector to access their card wallet. Testing of selectors that have been implemented using the conventional IMI transaction model have repeatedly shown that this additional per-card authentication challenge is considered both unintuitive and unwanted by principals (and therefore counter to the interests of RPs who want card authentication to introduce as little friction as possible). However it is not practical for an IP to lower or eliminate their card authentication requirements without destroying the value of the security token they provide to an RP.

To understand the benefits of brokered authentication, consider the situation today of a user having several managed information cards in their Microsoft CardSpace (or other non-brokered authentication-supporting) selector. It is very likely that each of these managed cards uses a separate password for authenticating the principal to the card issuer. Every time the principal wishes to use one of these cards, they are prompted for a password.

By contrast, consider the same situation if the selector 200 supports brokered authentication. In this case every the principal 101 wishes to use one of these cards they must only authenticate themselves to the selector, and thus is prompted to enter the same “master” password each time. From the principal's point of view the number of required passwords has been dramatically reduced and convenience commensurately increased. If multiple cards are used one after another the improvement is even more noticeable, since the principal would only be prompted once for the set of cards.

Brokered authentication solves this problem by reusing the authentication session principal 101 has already established with primary broker 301 in order to use their selector 200 to access their card wallet. The basic ISCP authentication credential is already strong because due to ISCP provisioning it includes three factors: 1) the selector i-number 525, 2) principal password 532, and 3) principal passphrase 534. Selector i-number 525 is registered in a one-time interaction between selector 200 and primary broker 301 and thereafter is not exposed outside of interactions with the primary broker 301, which all take place under the confidentiality protections of the HTTPS protocol. Principal password 532 and principal passphrase 534, which in a preferred embodiment are combined into primary broker password 536 for presentation to primary broker, should only be known to the principal 101. Both can meet initial entropy tests enforced by the selector, and can be subject to maximum duration and other password and passphrase security policies enforced by selector 200 and primary broker 301. Also, although selector i-number 525 and principal passphrase 534 are typically stored in the host device by the selector, in a preferred embodiment such storage uses the security protections previously discussed so that they are not accessible by any process other than the selector. In addition, as previously mentioned, if a TPM is available selector 200 may use it for hardware-level protection of these stored secrets.

However if for a particular IP or a particular card the standard ISCP authentication factors are not enough, primary broker 301 has the full range of options available to authentication authorities (also called “identity providers”) to increase the strength of the authentication session establish by principal 101. An inventory of these options is provided by the “Authentication Context for the OASIS Security Assertion Markup Language (SAML) V2.0” specification published by the OASIS Security Services Technical Committee at http://docs.oasis-open.org/security/saml/v2.0/saml-authn-context-2.0-os.pdf, referred to herein as “SAML Authentication Context”. Certain of these options are specifically relevant to principal/primary broker authentication due to the unique ability of having an ISCP-provisioned selector operating on the client device.

The first option is using device fingerprinting: the ability of a software program residing on a client device to obtain and create a compact summary of software and hardware settings that uniquely identify the device in the same manner as a human fingerprint uniquely identifies a person. Device fingerprinting options are described in the Wikipedia article at the permanent link http://en.wikipedia.org/w/index.php?title=Device_fingerprint&oldid=245326745. A common example of such a setting is the Media Access Control address (MAC address), the identifier assigned to most network adapters or network interface cards (NICs) by the manufacturer for identification.

A much stronger form of device fingerprinting is possible if the host device has a Trusted Platform Module (TPM) installed. In this case the TPM can produce a “remote attestation”, a nearly unforgeable hash key summary of the hardware and software configuration of the host device which also enables the primary broker to verify that the selector software 200 has not been changed. This capability of a TPM is generally described by the Wikipedia article at the permanent link http://en.wikipedia.org/w/index.php?title=Trusted_Platform_Module&oldid=239003681.

A second option is IP address authentication, described in section 3.4.1 of SAML Authentication Context. Unlike device fingerprinting, this characteristic of a client device may change over time, however in many cases it will still fall into one of a small set of allowable ranges that may be enrolled with the primary broker 301. IP address authentication has the advantage of being independently verifiable by the primary broker at the IP protocol level when the authentication request message is submitted by selector 200.

Because they are attributes of the device hosting selector 200, both device fingerprinting claims and an IP address claim may be included as additional authentication factors in the Get Authentication Credential message 3501, FIG. 35, simply by including them alongside the $password predicate as additional predicates of the {selector i-number} subject.

Another option is integrating the selector with a visual password authentication scheme such as those developed by Passfaces Corporation of Oak Hill, Va., USA (http://passfaces.com) or Vidoop Corporation of Portland, Oreg., USA (http://vidoop.com, also described in the Wikipedia article at the permanent link http://en.wikipedia.org/w/index.php?title=Vidoop&oldid=241774479). Such schemes do not rely on character-based passwords that can be subject to keyloggers or other spyware. Instead they employ human cognitive recognition capabilities to pick out a sequence of images such as faces or photographs from a matrix, a process that can be easier to remember and harder to guess than traditional passwords.

Visual password authentication may be integrated with selector 200 by having selector 200 request the image matrix from the primary broker in the same fashion as the CAPTCHA request messages described in FIG. 8 and FIG. 9. Primary broker 301 returns the image matrix to the selector together with a image matrix identifier value such as $password$image$ {image-matrix-id}. Selector 200 then displays the image matrix to principal 101 and records the selection sequence. Selector 200 returns the selection sequence as the value of the $password$image$ {image-matrix-id} predicate as a replacement for the standard ISAP $password credential in messages from the selector to the primary broker.

Another option which can be used if the principal 101 has been using the selector 200 for sufficient time. The principal can be challenged to answer questions about the history of interactions that they have been involved with using this particular selector. They could be asked, for example, questions as to which cards they have and haven't used at certain websites in some previous time interval.

Another option is integrating the selector with a hardware or software authentication token mechanism such as the SecurID token sold by RSA Security Corporation described in the Wikipedia article at the permanent link http://en.wikipedia.org/w/index.php?title=SecurID&oldid=243490527. Such token mechanisms employ a piece of hardware such as a key fob or USB key or a “soft token” operating on a PDA or cell phone that generates a unique authentication code at fixed intervals (typically less than a minute) using a built-in clock and the card's factory-encoded random key known as the “seed”. The seed is different for each token, and is loaded into the corresponding server as the tokens are purchased or assigned to principals.

Such a hardware token mechanism may also integrate a biometric credential. Biometric authentication is described generally by the Wikipedia article at the permanent link http://en.wikipedia.org/w/index.php?title=Biometrics&oldid=246537356. An example is the plusID personal biometric token sold by Privaris Corporation of Charlottesville, Va., USA (http://www.privaris.com) and described at http://www.privaris.com/pdf/plusID_datasheet.pdf. Once principal 101 has properly enrolled a biometric such as a fingerprint scan in biometric authentication system, it has the advantage of providing stronger proof that the actual principal is present at the point of authentication. It is also not subject to being lost or forgotten in the same manner as certain other authentication credentials, although biometric credentials may be subject to their own challenges such as change over time.

To be integrated with selector 200 as additional authentication factors for principal 101, hardware or software tokens and biometric credentials must first be enrolled with primary broker 301. Once enrolled, the selector may submit the corresponding token values or biometric values as additional authentication factors to the primary broker by adding new predicates to the {selector i-number} subject in the same manner as previously described.

Another option is using an independent second communications channel for authentication. This has already been illustrated with in the password recovery sequence shown in FIG. 28. The account recovery code 531, delivered to principal 101 via one of the communications channels enrolled with primary broker 301 as account recovery data 538, is used as a second-channel authentication factor. However second-channel authentication can also be used for real time authentication, particularly via the wired/wireless telephone network. This option is covered in sections 3.4.18 through 3.4.21 of SAML Authentication Context. The speed of SMS (Short Message Service) makes it practical for delivery of second-channel authentication tokens. An even simpler option is using an interactive touchtone or voice response to a telephone call. JanRain Corporation of Portland, Oreg., USA (http://janrain.com) in conjunction with PhoneFactor (http://www.phonefactor.com/) currently offers such a service for OpenID second-factor authentication under the trademark “CallVerifID”. As described at https://www.myopenid.com/about_callverifid, the principal must first enroll their phone number (typically a cell phone number). When the JanRain OpenID provider receives an authentication request from an enrolled principal, it immediately places a call to the enrolled number. The principal need only answer the call and press the # key to authenticate.

Second-channel authentication is particularly effective for brokered authentication because it is much more difficult to attack than single-channel authentication. It cannot be compromised even by gaining complete control of a single device. It also uniquely leverages the ability of primary broker 301 to communicate with principal 101 via multiple communications channels, a capability not available to a card selector operating independently on a principal's client device.

Another option is integrating the selector with knowledge-based authentication, referred to as Knowledge Based Authentication (KBA). Rather than a memorized secret, KBA relies on a principal's knowledge of own past transaction history and relationships. Strong KBA relies on “out of wallet” information, i.e., knowledge that would not be available to an attacker even if the attacker stole the principal's wallet and thus gained intimate knowledge of the principal's conventional identification credentials. An example is KBA services offered by IDology of Atlanta, Ga., USA (http://idology.com) under the “ExpectID IQ” trademark and described at http://www.idology.com/knowledge.html.

Primary broker 301 has two basic options for offering KBA to principal 101. The first is using a third-party KBA service provider. The second is performing KBA based on a principal's knowledge of the non-blinded contents and transaction history of their own card wallet. The former may involve questions such as former addresses, employment history, or the sources or amounts of past credit transactions. The latter may involve questions such as card i-names assigned to specific cards, recently created principal cards, recently accepted third-party cards, past card transaction history, or knowledge of password recovery answers 540A. Wallet-based questions whose answers are discoverable from direct inspection of the card wallet may only be used to authenticate a principal at the start of a new wallet authentication session.

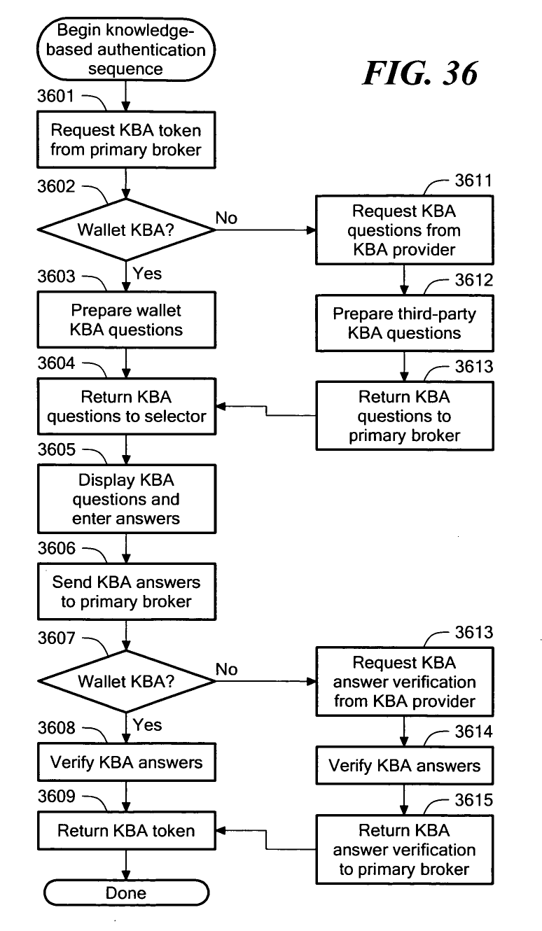

FIG. 36 is a flow diagram of the steps involved with selector 200 obtaining a KBA token to include in an RST. In step 3601, selector 200 requests a KBA token from primary broker 301 by sending the Get Authentication Credential message 3501, FIG. 35, with the modification that the final XDI statement would be $$/$is$a/$password$kba. Step 3602, FIG. 36, is a test of whether primary broker 301 is using wallet KBA or a third-party KBA provider. If a third-party KBA provider, in step 3611, primary broker 301 requests the KBA questions from the third-party provider by providing a set of identifying information for principal 101 and any other metadata required. This request and the response may use any protocol or interface agreed upon between primary broker 301 and the third-party KBA provider. In step 3612 the KBA provider prepares the KBA questions based on the information identifying the principal. In step 3613 the KBA provider returns the KBA questions to the primary broker. If using wallet KBA, in step 3603, primary broker 301 prepares the wallet KBA questions. In either case, in step 3604, primary broker 301 returns the KBA questions to the selector in a message similar to the Get Password Recovery Question: Success message 2902RT, FIG. 29C.

In step 3605, FIG. 36, selector UI module 220 displays the KBA questions and prompts principal 101 to enter the answers. In a preferred embodiment, this challenge includes an explanation to the principal that KBA is necessary to authenticate to the IP or card selected by the principal. In step 3606, FIG. 36, selector 200 returns the principal's answers to primary broker 301. Step 3607 is again a test of whether wallet KBA or third-party KBA applies. If third-party KBA, in step 3613, primary broker 301 sends the third-party KBA provider a request for verification of the KBA answers. In step 3614, the KBA provider verifies the principal's answers. Assuming verification, in step 3615, the KBA provider returns the verification to primary broker 301. If wallet KBA was used, in step 3608, primary broker 301 verifies the KBA answers. In either case, assuming the answers verify, in step 3609 primary broker 301 returns the requested KBA token, and selector 200 may proceed with the RST message to the IP 401.

Another advantage of brokered authentication is that primary broker 301 can provide authentication claims transformation services. Claims transformation as described by the IMI specifications and associated documentation is the process of an STS accepting a first set of claims from principal 101 or another IP 401 and transforming them into a second set of claims for an RP 402. A common example is when an RP's security policy requires a claim that a principal's age is greater than 21, but the claim input to an IP's STS is the principal's precise birthdate. In this case the STS can perform a claims transformation to return a boolean TRUE/FALSE claim of “age-greater-than-21” to the RP, thereby not revealing either the principal's precise age or birthdate.

Primary broker 301 may perform the same service for authentication claims. For example, it may take the authentication scheme required by a card from an IP as an input and determine whether the authentication credential(s) currently submitted by principal 101 meet the requirements of the requested authentication scheme. If not, primary broker 301 may “bump up” the principal's authentication level by challenging the principal once for the additional authentication credentials required.

In addition to claims transformation into the authentication token format required by an IP 401, primary broker 301 can also provide the IP with a richer set of authentication context claims. For example, while one of the four standard authentication schemes supported by the IMI V1.0 specifications is a principal card, and such a credential can be submitted directly by a card selector using its own local STS, such a card has a fixed set of standard claims, none of which convey authentication context information. However if a primary broker acts as its own IP, it can issue a third-party card or set of cards that offer a rich set of brokered authentication claims. Such a card or cards could include all the claims described herein; all the claims defined in the SAML Authentication Context specification; claims defined by other authentication context or assurance frameworks such as the “Electronic Authentication Guideline” published by the National Institute of Standards and Technology (NIST) as NIST Special Publication 800-63 Version 1.0.2 available at http://csrc.nist.gov/publications/nistpubs/800-63/SP800-63V1_{—}0_{—}2.pdf, or any other authentication claims required by IPs 401.

In this case, IP 401 can formally act in the role of an RP 402 for the purpose of accepting an authentication token from primary broker 301 as an IP. This requires the IP to formally publish its own security policy to the primary broker describing the claims it requires and the security token types it accepts for authentication of principal 101 with regard to a particular card. This enables the primary broker to precisely produce the set of claims required by the target IP in the token type requested by the IP.

Although such authentication claims may be transferred automatically between the primary broker 301 and the IP 401 on behalf of principal 101, in a preferred embodiment, principal 101 may be given explicit control over such authentication via a brokered authentication card. This is a card formally issued by primary broker 301 to principal 101 to represent the authentication relationship with IPs 401 who accept that brokered authentication card. The principal may then choose the IP and/or card relationships for which their selector should automatically “remember this card” and authenticate them automatically vs. which the relationships for which the principal wishes to provide manual consent.

Another special type of brokered authentication scheme is a broker-issued one-time password, also referred to as an OTP. One-time passwords are generally described in the Wikipedia article with the permanent link http://en.wikipedia.org/w/index.php?title=One-time_password&oldid=245813937. One-time passwords are based on shared knowledge of the OTP generation algorithm by both the issuer and the relying party. In the case of a broker-issued OTP, the primary broker 301 is the OTP issuer and IP 401 is the OTP relying party. Once the OTP algorithm is shared between primary broker 301 and the IP, any principal 101 using a card wallet from that primary broker may be authenticated to the IP by an OTP issued by primary broker 301. One advantage of this authentication scheme is efficiency: the authentication claim is very small and the IP only needs to perform an efficient algorithmic check on the OTP instead of verifying a cryptographic signature from primary broker 301. Another advantage is that this scheme will worth with the standard IMI username/password token type instead of the more complex token types. A third advantage is that primary broker may use different OTP algorithms to convey OTPs corresponding to different authentication credentials or contexts. For example, four different OTP algorithms may be used to represent the four authentication assurance levels defined in the NIST “Electronic Authentication Guideline” described above.

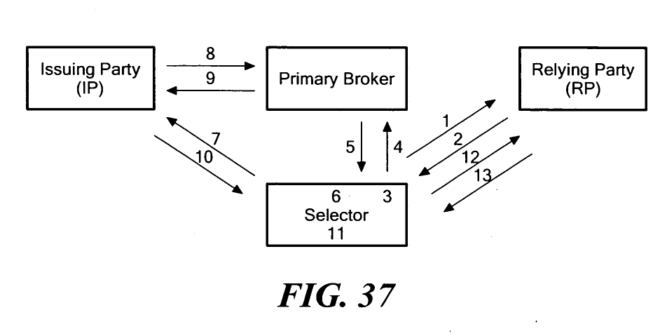

Another special type of brokered authentication scheme involves direct backchannel communications between IP 401 and primary broker 301. FIG. 37 is a conceptual diagram showing how the protocol flow for this model differs from FIG. 30C. Steps 7 and 8 in FIG. 30C, where selector 200 requests an authentication credential for principal 101 and primary broker 301 returns it, are replaced by steps 8 and 9 in FIG. 37, in which the IP requests an authentication token for principal 101 directly from primary broker 301 and primary broker 301 returns it. Since primary broker 301 is releasing authentication information about principal 101 directly to a third party, this model requires prior authorization by principal 101. This stored consent is referred to as an “authentication contract”. Principal 101 may consent to an authentication contract at the time principal 101 first accepts a card from an IP, or anytime thereafter. If the card specifies the ability to use an authentication contract and principal 101 elects this option, selector 200 notifies principal broker 301 when sending Add Card message 3201, FIG. 32, by adding the $contract$authentication predicate to the $$ variable and specifying the IP identifier as the object.

If a card is associated with an authentication contract, selector 200 may skip steps 7 and 8, FIG. 30C, and submit the RST directly to the IP with an authentication contract token. This token contains an authentication contract identifier, and optionally a nonce. In a preferred embodiment, the authentication contract identifier is either the card i-number 529 or a privacy-protecting pseudonymous i-number generated by primary broker 301 that may be resolved by IP 401 to the primary broker 301 and by primary broker 301 to the authentication contract. The IP uses the authentication contract identifier to make an authentication request to primary broker 301. This request may use any protocol or interface previously agreed to between the IP and primary broker 301. In a preferred embodiment, it uses the XDI protocol as described herein and primary broker 301 ISCP endpoint 551. Primary broker 301 authenticates the IP as required, verifies the authentication contract, and verifies the principal's authentication, and returns a response to the IP.

The security of this protocol can be further improved if the authentication contract token includes a nonce generated by primary broker 301 and returned to selector 200 in Get Card Response 3401R message, FIG. 34. This nonce is then passed by selector 200 to IP 401 in the authentication contract token and finally returned to and verified by the primary broker in the authentication request from the IP to the primary broker. This prevents unauthorized requests from an IP as well as replay attacks.

Like the broker OTP model, the authentication contract model can be very efficient. Another advantage is that it allows IP 401 to dynamically communicate the IP's security policy requirements directly via the authentication query to primary broker 301 instead of via a static predefined security policy document. This enables the IP to customize the authentication requirements based on a particular card, a particular principal, a particular time or date, a particular primary broker, or any other dynamic security policy variable. One disadvantage of this authentication model is that the primary broker gains direct knowledge of when a principal is using a particular card from a particular IP, a requirement that can be avoided when the authentication credential request is submitted by selector 200, FIG. 30C.

In addition to brokered authentication, primary broker 301 is also in a unique position to provide claims describing characteristics of a principal's card wallet service. These include claims about other claims (“metaclaims”), as well as claims about cards, card transaction history, and primary broker interactions, collectively referred to as broker heuristics. Broker heuristics can provide valuable relationship metadata to both IPs 401 and RPs 402.

One category of broker heuristics is claims about the principal's enrollment in the card wallet service. For example, primary broker 301 can provide a claim concerning whether the principal passed a CAPTCHA test or a KBA test; whether the principal supplied a verified email address or SMS address; whether the principal has a verified postal address or legal jurisdiction; and whether the principal has performed age verification. Related heuristics are the age of each of these claims and how often these verifications were performed.

Another category of broker heuristics is claims regarding overall characteristics of the principal's card wallet, such as the age of the account, the frequency of usage of the account, the period since last usage, the number of selectors provisioned for the account, the age of the selector currently being used, how many times the principal has been authenticated at the selector currently being used, the type of host device for the selector currently being used (e.g., mobile or fixed, or other information available from device fingerprinting as described above).

Another category is claims regarding the cards in the wallet, such as the total number of cards, the number of principal cards, the number of third-party cards, the total number of card sharing transactions, and the average age of the cards. Still another category is claims concerning a specific card, such its age, frequency of usage, period since last usage, frequency of update, and period since last update.

In addition to individual metrics, a primary broker may also provide claims represented aggregated characteristics, metrics, or “scores” of a particular card, groups of cards, or the wallet as a whole. These are analogous to the metrics and scores provided by credit bureaus regarding an individual's or company's credit history, and they can be used for similar purposes, in particular to help prevent fraud or identity theft.

Broker heuristics can also be subject to the same privacy concerns as credit histories. A particular advantage of brokered information sharing system 100 is that the sharing of broker heuristics can be subject to the same security and privacy controls as the sharing of any other information regarding principal 101. For example, primary broker 301 may issue one or more cards directly to the principal to represent their relationship. Such cards, referred to as broker cards, may include claims controlling the gathering and sharing of broker heuristics. For example, the principal may elect via a broker card for a broker to automatically share broker heuristics with IP 401 or RP 402 that the principal has passed a KBA test to enroll in the card wallet service and has a verified email address and SMS address, but for the broker not to share metrics about third-party card transaction histories without requesting the principal's explicit consent. Broker cards provide a mechanism for principals to be directly involved in decisions regarding sharing of broker heuristics in the same way they control the release of claims from any other IP.

Broker heuristic claims may be shared directly between primary broker 301 and IP 401 by including them in brokered authentication credentials as described above. They may also be shared directly between the primary broker 301 acting as IP 401 and RP 402 whose security policy requests broker heuristic claims directly. A third option is for a broker heuristic to flow through from the primary broker to the IP in a brokered authentication credential, and then for the IP to dynamically include this claim in the security token it returns to selector 200 to forward to the RP. The more widely desired the broker heuristic claim, such as, “Has this principal passed a CAPTCHA?” or “Does this individual have a verified email address?”, the more value it provides to principals, IPs, and RPs to reuse this claim automatically throughout the chain of relationships.

However, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A brokered information sharing system comprising:
a primary broker configured with software to store cards of a principal, to transmit said cards when requested by the principal, to authenticate the principal, and to provide a master authentication of the principal to at least one issuing party; and
a selector used by the principal and configured with software to provide authentication of the principal to the primary broker, and to request and receive cards from the primary broker.

2. The system of claim 1 in which the master authentication is for authenticating a plurality of the cards each selected by the selector.

3. The system of claim 1 in which the selector is programmed to analyze a security policy provided by an information source and the selector includes a communications module configured to compose a message transmitted to the remote broker.

4. The system of claim 3 in which the message includes a broker password which allows access to the primary broker.

5. The system of claim 4 in which the primary broker includes programming for verifying the broker password.

6. The system of claim 3 in which the primary broker includes one or more databases for storing the cards and a data adapter which queries the databases in accordance with the message.

7. The system of claim 1 in which the primary broker is further configured to authenticate a card transmitted to the selector upon request by the selector.

8. The system of claim 7 in which the selector is programmed to request a card authenticated from the primary broker.

9. The system of claim 8 in which the selector includes a cryptography module which produces a security token based on the card authentication transmitted from the primary broker.

10. The system of claim 7 in which authentication includes a selector identification and a password.

11. The system of claim 1 in which at least some of the information in the cards stored at the primary broker is encrypted.

12. The system of claim 11 further including at least one encryption key for the cards and an encryption key repository remote from the broker for storing the at least one encryption key.

13. The system of claim 12 in which the selector is programmed to retrieve the encryption key from the encryption key repository for decrypting an encrypted card transmitted to the selector by the broker.

14. The system of claim 1 in which the software of the primary broker is configured to store the cards remotely from the selector.

15. The system of claim 1 in which the primary broker authenticates the principal using device fingerprinting.

16. The system of claim 1 in which the primary broker authenticates the principal using a trusted platform module.

17. The system of claim 1 in which the primary broker authenticates the principal using IP address authentication.

18. The system of claim 1 in which the primary broker authenticates the principal using knowledge based authentication.

19. The system of claim 1 in which the primary broker authenticates the principal using a broker-issued one-time password.

20. The system of claim 1 in which the primary broker authenticates the principal using a hardware authentication token mechanism.

21. The system of claim 1 in which the primary broker authenticates the principal using a software authentication token mechanism.

22. The system of claim 1 in which the primary broker authenticates the principal using broker heuristics.

23. The system of claim 22 in which the broker heuristics uses information relating to the enrollment of the principal in a card wallet service.

24. The system of claim 22 in which the broker heuristics uses information relating to the characteristics of a card wallet of the principal.

25. The system of claim 22 in which the broker heuristics uses information relating to the cards in a card wallet of the principal.

26. The system of claim 22 in which the broker heuristics uses information relating to the characteristics of a group of cards from a card wallet of the principal.

27. A brokered information sharing system for a principal using a selector, the system comprising:
a primary broker configured with software to remotely store cards of a principal, to transmit said cards when requested by the principal, and to authenticate the principal upon request by the selector, and to provide a master authentication of the principal to at least one issuing party; and
wherein the selector is used by the principal and configured with software to request cards from the broker, to receive cards transmitted from the broker, and to request card authentication from the broker.

28. A brokered information sharing system comprising:
a primary broker remote from a principal including:
a database for storing cards of a principal, the cards having at least some information therein encrypted,
a data adapter configured to query the database in response to a message,
means for authenticating a retrieved card, and
means for transmitting the card and the authentication;
a selector including:
a communications module configured to compose the message based on a security policy and to transmit the message to the primary broker, and
a cryptography module configured to provide a security token based on the authentication received from the primary broker; and
an encryption key repository configured to store at least one encryption key of the principal and to transmit the encryption key to the selector upon request by the selector to decrypt the encrypted information in a card transmitted to the selector by the primary broker.

29. The system of claim 28 in which the message includes a broker password which allows access to the primary broker.

30. The system of claim 29 in which the primary broker includes programming for verifying the broker password.

31. The system of claim 28 in which authentication includes a selector identification and a password.

32. A brokered information sharing system comprising:
a primary broker comprising means for storing cards of a principal, means for transmitting a said card when requested by the principal, means for authenticating the principal, and means for providing a master authentication of the principal to at least one issuing party; and
a selector used by the principal and including means for requesting cards from the remote broker and to receive cards transmitted from the broker.

33. A brokered information sharing method comprising:
configuring a primary broker to remotely store cards of a principal, to transmit cards when requested by the principal, to authenticate the principal, and to provide a master authentication of the principal to at least one issuing party; and
configuring a selector for use by the principal to request cards from the remote broker and to receive cards transmitted from the broker.

34. The method of claim 33 in which the selector analyzes a security policy provided by an information source and composes a message transmitted to the remote broker.

35. The method of claim 34 in which the message includes a broker password which allows access to the primary broker.

36. The method of claim 35 in which the primary broker verifies the broker password.

37. The method of claim 34 in which the primary broker includes one or more databases for storing the cards and the broker queries the databases in accordance with the message.

38. The method of claim 33 in which the primary broker authenticates a card transmitted to the selector upon request by the selector.

39. The method of claim 38 in which the selector requests a card authenticated from the primary broker.

40. The method of claim 38 in which the selector produces a security token based on the card authorization transmitted from the primary broker.

41. The method of claim 38 in which authentication includes a selector identification and a password.

42. The method of claim 33 in which the cards stored at the primary broker are encrypted.

43. The method of claim 42 further including storing at least one encryption key for the cards at an encryption key repository remote from the broker.

44. The method of claim 43 in which the selector retrieves the encryption key from the encryption key repository for decrypting an encrypted card transmitted to the selector by the broker.

45. A brokered information sharing method comprising:
configuring a primary broker with software to store cards of a principal, to transmit said cards when requested by the principal, to authenticate the principal upon request by the selector, and to provide a master authentication of the principal to at least one issuing party; and
configuring a selector used by the principal with software to request cards from the remote broker, to receive cards transmitted from the broker, and to request card authentication from the primary broker.

46. A brokered information sharing method comprising:
provisioning a primary broker remote from a principal to:
store encrypted cards of a principal in a database,
query the database in response to a message,
authenticate a retrieved card, and
transmit the card and the authentication;
provisioning a selector to:
compose the message based on a security policy and to transmit the get card message to the primary broker, and
provide a security token based on the authentication received from the primary broker; and
provisioning a repository to store at least one encryption key of the principal and transmit the encryption key to the selector upon request by the selector to decrypt a card transmitted to the selector by the primary broker.

47. The method of claim 46 in which the message includes a broker password which allows access to the primary broker.

48. The method of claim 47 in which the primary broker verifies the broker password.

49. The method of claim 46 in which authentication includes a selector identification and a password.

50. A brokered information sharing method comprising:
storing cards of a principal and transmitting a said card when requested by the principal;
requesting cards from the broker and receiving cards transmitted from the broker;
authenticating the principal; and
providing a master authentication of the principal.
